(19) United States
(12) Patent Application Publication
(10) Pub. No.: US 2026/0019579 A1
(43) Pub. Date: Jan. 15, 2026

(54) ENCODING DEVICE, DECODING DEVICE, ENCODING METHOD, AND DECODING METHOD

(71) Applicant: Panasonic Intellectual Property Corporation of America, Torrance, CA (US)

(72) Inventors: Jingying GAO, Singapore (SG); Han Boon Teo, Singapore (SG); Chong Soon Lim, Singapore (SG); Praveen Kumar Yadav, Singapore (SG); Kiyofumi Abe, Osaka (JP); Takahiro Nishi, Nara (JP); Tadamasa Toma, Osaka (JP)

(21) Appl. No.: 19/333,794

(22) Filed: Sep. 19, 2025

Related U.S. Application Data
(63) Continuation of application No. PCT/JP2024/008152, filed on Mar. 4, 2024.
(60) Provisional application No. 63/454,138, filed on Mar. 23, 2023.

(51) Int. Cl. H04N 19/119; H04N 19/136; H04N 19/176; H04N 19/182; H04N 19/184; H04N 19/70

(52) U.S. Cl. CPC H04N 19/119; H04N 19/136; H04N 19/176; H04N 19/182; H04N 19/184; H04N 19/70

(57) ABSTRACT

This encoder comprises circuitry and a memory connected to the circuitry. The circuitry generates a plurality of feature maps by means of a neural network having one or more layers on the basis of an input image to be processed, generates a plurality of unit feature maps on the basis of the plurality of feature maps by packing a plurality of pixels included in at least one feature map into at least one encoded block, generates a picture by arranging a plurality of encoded blocks corresponding to the plurality of unit feature maps, and encodes the picture into a bitstream, and in the generation of the unit feature maps, the upper left boundary of each unit feature map is matched with the upper left boundary of any encoded block.

### FIELD OF INVENTION

The present disclosure relates to an encoder, a decoder, an encoding method, and a decoding method.

### BACKGROUND ART

Faster-RCNN is configured to include a first neural network (feature pyramid network) that generates a plurality of feature maps and a second neural network (region proposal network) that extracts a region of interest (ROI) from the feature maps.

Patent Literatures 1 and 2 disclose an object detection method using Faster-RCNN.

An encoder according to the background art arranges a plurality of feature maps in order from an upper left of a picture. Therefore, there is a case where boundaries of a plurality of feature maps are included in one encoded block, and the compression efficiency in encoding the plurality of feature maps is poor.
Patent Literature 1: Chinese Patent Application Publication No. 109344897
Patent Literature 2: Chinese Patent Application Publication No. 109785333

### SUMMARY OF THE INVENTION

An object of the present disclosure is to improve the compression efficiency in encoding a plurality of feature maps.

An encoder according to one aspect of the present disclosure includes circuitry, and a memory connected to the circuitry. The circuitry is configured to execute generating a plurality of feature maps by means of a neural network having one or more layers based on an input image to be processed, generating a plurality of unit feature maps based on the plurality of feature maps by packing a plurality of pixels included in at least one feature map into at least one encoded block, generating a picture by arranging a plurality of encoded blocks corresponding to the plurality of unit feature maps, encoding the picture into a bitstream, and matching, in the generating of the unit feature maps, an upper left boundary of each unit feature map with an upper left boundary of any encoded block.

### BRIEF DESCRIPTION OF THE DRAWINGS

FIG. 1 is a diagram illustrating, in a simplified manner, a configuration of an image processing system according to an embodiment of the present disclosure.

FIG. 2 is a flowchart illustrating processing executed by an information processing unit of the encoder.

FIG. 3 is a diagram illustrating an example of a plurality of feature maps.

FIG. 4 is a diagram schematically illustrating generation processing of a unit feature map and generation processing of a picture.

FIG. 5A is a diagram illustrating, in a simplified manner, a method of packing a pixel set into an encoded block.

FIG. 5B is a diagram illustrating, in a simplified manner, a method of packing a pixel set into an encoded block.

FIG. 5C is a diagram illustrating, in a simplified manner, a method of packing a pixel set into an encoded block.

FIG. 6 is a diagram illustrating an example of a picture in a simplified manner.

FIG. 7 is a diagram illustrating another example of a picture in a simplified manner.

FIG. 8 is a diagram schematically illustrating a bitstream.

FIG. 9 is a diagram illustrating a first example of syntax information.

FIG. 10 is a diagram illustrating a second example of syntax information.

FIG. 11 is a diagram illustrating a third example of syntax information.

FIG. 12 is a diagram illustrating a fourth example of syntax information.

FIG. 13 is a diagram illustrating a fifth example of syntax information.

FIG. 14 is a diagram illustrating a sixth example of syntax information.

FIG. 15 is a diagram illustrating a seventh example of syntax information.

FIG. 16 is a diagram illustrating index information in a simplified manner.

FIG. 17 is a diagram schematically illustrating a modification of generation processing of a unit feature map.

FIG. 18 is a diagram schematically illustrating a modification of generation processing of a picture.

FIG. 19 is a diagram schematically illustrating a modification of generation processing of a unit feature map and generation processing of a picture.

FIG. 20A is a diagram illustrating an example of a unit feature map and an encoded block set.

FIG. 20B is a diagram illustrating an example of a unit feature map and an encoded block set.

FIG. 20C is a diagram illustrating an example of a unit feature map and an encoded block set.

FIG. 21 is a diagram illustrating another example of a picture in a simplified manner.

FIG. 22 is a flowchart illustrating an example of switching processing between a first generation method and a second generation method in units of pictures.

FIG. 23 is a flowchart illustrating processing executed by an information processing unit of a decoder.

FIG. 24 is a diagram schematically illustrating reconstruction processing of a feature map in correspondence with FIG. 4.

FIG. 25 is a diagram schematically illustrating reconstruction processing of a feature map in correspondence with FIG. 17.

FIG. 26 is a diagram schematically illustrating reconstruction processing of a feature map in correspondence with FIG. 19.

### DETAILED DESCRIPTION

### (Knowledge Underlying Present Disclosure)

Faster-RCNN is known as a model in which a region based convolutional neural network (R-CNN), which is a region-based object detection model is sped up. In Faster-RCNN, a plurality of feature maps having different sizes in each hierarchical layer are generated by performing convolution processing on an input image of a processing target using the first neural network (feature pyramid network) of a plurality of hierarchical layers. Then, by applying the generated feature map with an RP model using the second neural network (region proposal network), an ROI region is extracted from the feature map, and image recognition is performed on the extracted ROI region.

For example, in a surveillance camera system, in a case where processing using the first neural network is performed on the camera side and processing using the second neural network is performed on a server device side, an encoder generates a bitstream by encoding a feature map generated using the first neural network, and transmits the generated bitstream to a decoder. The decoder reconstructs the feature map by decoding the received bitstream, and performs processing using the second neural network on the reconstructed feature map.

However, the data amount of the feature map is enormous as compared with the data amount of an input image of a processing target, and thus the data amount of the bitstream transmitted from the encoder to the decoder also increases. In particular, an encoder according to the background art arranges a plurality of feature maps in order from an upper left of a picture. Since the feature map is generated by performing a plurality of layers of convolution processing on the input image, the spatial correlation between the feature maps may be low. In addition, the size of an encoded block in a video codec such as VVC or HEVC is different from the size of a feature map. Therefore, in a picture in which a plurality of feature maps are simply arranged, boundaries of the plurality of feature maps may be included in one encoded block, and the compression efficiency at the time of encoding is poor.

In order to solve such a problem, the present inventors have found that the above problem can be solved by generating a plurality of unit feature maps based on a plurality of feature maps by packing a plurality of pixels included in a feature map in an encoded block and matching an upper left boundary of each unit feature map with an upper left boundary of any encoded block, and have arrived at the present disclosure.

Next, each aspect of the present disclosure will be described.

An encoder according to a first aspect of the present disclosure includes circuitry, and a memory connected to the circuitry. The circuitry is configured to execute generating a plurality of feature maps by means of a neural network having one or more layers based on an input image to be processed, generating a plurality of unit feature maps based on the plurality of feature maps by packing a plurality of pixels included in at least one feature map into at least one encoded block, generating a picture by arranging a plurality of encoded blocks corresponding to the plurality of unit feature maps, encoding the picture into a bitstream, and matching, in the generating of the unit feature maps, an upper left boundary of each unit feature map with an upper left boundary of any encoded block.

According to the first aspect, since the upper left boundary of each unit feature map is matched with the upper left boundary of any encoded block, the compression efficiency at the time of encoding can be improved.

According to a second aspect of the present disclosure, in the encoder of the first aspect, the picture may be a plurality of pictures, and in the generating of the picture, a plurality of encoded blocks corresponding to a plurality of unit feature maps having different layers may be arranged in different pictures.

According to the second aspect, since picture is different for each layer, decoding processing can be facilitated.

According to a third aspect of the present disclosure, in the encoder of the first aspect, the picture may include a plurality of sectioned regions, and in the generating of the picture, a plurality of encoded blocks corresponding to a plurality of unit feature maps having different layers may be arranged in different sectioned regions.

According to the third aspect, since the sectioned region is different for each layer, the decoding processing can be facilitated.

According to a fourth aspect of the present disclosure, in the encoder of the third aspect, the sectioned region may include a sub-picture, a tile, or a slice.

According to the fourth aspect, since the sub-picture, the tile, or the slice is different for each layer, the decoding processing can be facilitated.

According to a fifth aspect of the present disclosure, in the encoder of any one of the first to fourth aspects, in encoding the bitstream, syntax information or index information designating a generation method of the unit feature map and a generation method of the picture may be encoded into a supplemental enhancement information (SEI) region or another header region of the bitstream.

According to the fifth aspect, since the syntax information or the index information designating the generation method of the unit feature map and the generation method of the picture is encoded into the SEI region or another header region of the bitstream, the decoding processing can be facilitated.

According to a sixth aspect of the present disclosure, in the encoder of any one of the first to fifth aspects, in generating the unit feature map, one unit feature map may be generated by collecting a pixel set at a same position included in each feature map from a plurality of feature maps included in each layer, and packing a plurality of collected pixel sets in one encoded block.

According to the sixth aspect, it is possible to improve the compression efficiency when encoding a plurality of feature maps having low spatial correlation.

According to a seventh aspect of the present disclosure, in the encoder of the sixth aspect, the pixel set may be one pixel or two or more adjacent pixels.

According to the seventh aspect, since the size of the encoded block can be appropriately set according to the number of pixels included in the pixel set, the compression efficiency at the time of encoding can be further improved.

According to an eighth aspect of the present disclosure, in the encoder of the sixth or seventh aspect, in generating the unit feature map, a size of an encoded block in each layer may be set based on a number of feature maps included in each layer and a number of pixels included in the pixel set.

According to the eighth aspect, since the size of the encoded block can be appropriately set for each layer, the compression efficiency at the time of encoding can be further improved.

According to a ninth aspect of the present disclosure, in the encoder of any one of the sixth to eighth aspects, in generating the unit feature map, a plurality of collected pixel sets may be arranged in the encoded block in a designated scan order.

According to the ninth aspect, since the unit feature map can be appropriately stored in the encoded block, the decoding processing can be facilitated.

According to a tenth aspect of the present disclosure, in the encoder of the ninth aspect, in generating the unit feature map, in a case where the encoded block includes a surplus pixel in which no pixel set is stored, the surplus pixel may be padded using a specific value.

According to the tenth aspect, since the surplus pixels of the encoded block are padded using the specific value, the compression efficiency at the time of encoding can be further improved.

According to an eleventh aspect of the present disclosure, in the encoder of any one of sixth to tenth aspects, in generating the picture, a number of encoded blocks included in each layer may be set based on a number of pixels of a feature map included in each layer and a number of pixels included in the pixel set.

According to the eleventh aspect, since the number of encoded blocks included in each layer can be appropriately set, the compression efficiency at the time of encoding can be further improved.

According to a twelfth aspect of the present disclosure, in the encoder of any one of the sixth to eleventh aspects, the picture may include a plurality of sectioned regions, in generating the picture, a plurality of encoded blocks corresponding to a plurality of unit feature maps having different layers may be arranged in different sectioned regions, and in a case where each sectioned region includes a surplus encoded block in which the unit feature map is not stored, the surplus encoded block may be padded using a specific value.

According to the twelfth aspect, since the surplus encoded block of the picture is padded using the specific value, the compression efficiency at the time of encoding can be further improved.

According to a thirteenth aspect of the present disclosure, in the encoder of any one of the sixth to twelfth aspects, the picture may include a plurality of sectioned regions, in generating the picture, a plurality of encoded blocks corresponding to a plurality of unit feature maps having different layers may be arranged in different sectioned regions, at least one of a number of feature maps and a number of pixels included in each layer may differ according to a layer, a size of an encoded block included in each layer may be different according to a number of feature maps included in each layer, and a number of encoded blocks included in each layer may differ according to a number of pixels of a feature map included in each layer.

According to the thirteenth aspect, since the size and the number of the encoded blocks included in each layer can be appropriately changed for each layer, the compression efficiency at the time of encoding can be further improved.

According to a fourteenth aspect of the present disclosure, in the encoder of any one of the sixth to thirteenth aspects, in generating the picture, a surplus encoded block may be padded using a specific value in a case where the surplus encoded block in which the unit feature map is not stored is included in at least one region of an upper end, a lower end, a left end, and a right end of the picture, and the padded region may be designated by crop information of the picture.

According to the fourteenth aspect, since the padded region is designated by the crop information of the picture, the decoding processing can be facilitated.

According to a fifteenth aspect of the present disclosure, in the encoder of any one of the first to fifth aspects, in generating the unit feature map, one unit feature map may be generated by packing one feature map into one encoded block set or by packing a plurality of feature maps into one encoded block set.

According to the fifteenth aspect, it is possible to improve the compression efficiency when encoding a plurality of feature maps having high spatial correlation.

According to a sixteenth aspect of the present disclosure, in the encoder of the fifteenth aspect, the encoded block set may be one encoded block or two or more adjacent encoded blocks.

According to the sixteenth aspect, since the size of the encoded block set can be appropriately set according to the number of pixels of the unit feature map, the compression efficiency at the time of encoding can be further improved.

According to a seventeenth aspect of the present disclosure, in the encoder of the fifteenth or sixteenth aspect, in generating the unit feature map, a size of an encoded block set in each layer may be set based on a number of pixels of a feature map included in each layer.

According to the seventeenth aspect, since the size of the encoded block set can be appropriately set based on the number of pixels of the feature map, the compression efficiency at the time of encoding can be further improved.

According to an eighteenth aspect of the present disclosure, the encoder of any one of the fifteenth to seventeenth aspects, in generating the unit feature map, in a case where the encoded block set includes a surplus pixel in which no unit feature map is stored, the surplus pixel may be padded using a specific value.

According to the eighteenth aspect, since the surplus pixels of the encoded block set are padded using the specific value, the compression efficiency at the time of encoding can be further improved.

According to a nineteenth aspect of the present disclosure, in the encoder of any one of the fifteenth to eighteenth aspects, in generating the picture, a number of encoded block sets included in each layer may be set based on a number of feature maps included in each layer.

According to the nineteenth aspect, since the number of encoded block sets included in each layer can be appropriately set, the compression efficiency at the time of encoding can be further improved.

According to a twentieth aspect of the present disclosure, in the encoder of any one of the fifteenth to nineteenth aspects, the picture may include a plurality of sectioned regions, in generating the picture, a plurality of encoded block sets corresponding to a plurality of unit feature maps having different layers may be arranged in different sectioned regions, and in a case where each sectioned region includes a surplus encoded block set in which the unit feature map is not stored, the surplus encoded block set may be padded using a specific value.

According to the twentieth aspect, since the surplus pixels in each sectioned region are padded using the specific value, the compression efficiency at the time of encoding can be further improved.

According to a twenty-first aspect of the present disclosure, in the encoder of any one of the fifteenth to twentieth aspects, the picture may include a plurality of sectioned regions, in generating the picture, a plurality of encoded block sets corresponding to a plurality of unit feature maps having different layers may be arranged in different sectioned regions, at least one of a number of feature maps and a number of pixels included in each layer may differ according to a layer, a number of encoded block sets included in each layer may be different according to a number of feature maps included in each layer, and a size of an encoded block set included in each layer may differ according to a number of pixels of a feature map included in each layer.

According to the twenty-first aspect, since the number and size of the encoded blocks included in each layer can be appropriately changed for each layer, the compression efficiency at the time of encoding can be further improved.

According to a twenty-second aspect of the present disclosure, in the encoder of any one of the fifteenth to twenty-first aspects, the picture may include a plurality of sectioned regions, in generating the picture, a plurality of encoded block sets corresponding to a plurality of unit feature maps having different layers may be arranged in different sectioned regions, a size of an encoded block included in each layer may be common in a plurality of layers, a number of pixels of a feature map included in each layer may differ according to a layer, and a number of encoded blocks included in an encoded block set in each layer may differ according to a number of pixels of a feature map included in each layer.

According to the twenty-second aspect, since the number of encoded blocks included in the encoded block set in each layer can be appropriately varied, the compression efficiency at the time of encoding can be further improved.

According to a twenty-third aspect of the present disclosure, in the encoder of any one of the fifteenth to twenty-second aspects, in generating the picture, a surplus encoded block set may be padded using a specific value in a case where the surplus encoded block set in which the unit feature map is not stored is included in at least one region of an upper end, a lower end, a left end, and a right end of the picture, and the padded region may be designated by crop information of the picture.

According to the twenty-third aspect, since the padded region is designated by the crop information of the picture, the decoding processing can be facilitated.

According to a twenty-fourth aspect of the present disclosure, in the encoder of any one of the first to fifth aspects, in generating the unit feature map, a first generation method of generating one unit feature map by collecting a pixel set at a same position included in each feature map from a plurality of feature maps included in each layer and packing a plurality of collected pixel sets in one encoded block, and a second generation method of generating one unit feature map by packing one feature map into one encoded block set or by packing a plurality of feature maps into one encoded block set may be switched in units of pictures or in units of layers.

According to the twenty-fourth aspect, since the first generation method and the second generation method can be appropriately switched in units of pictures or in units of layers according to the input image, the compression efficiency at the time of encoding can be further improved.

According to a twenty-fifth aspect of the present disclosure, in the encoder of any one of the first to twenty-fourth aspects, in encoding the bitstream, syntax information designating a number of the plurality of layers may be encoded into the bitstream.

According to the twenty-fifth aspect, since the syntax information designating the number of the plurality of layers is encoded into the bitstream, the decoding processing can be appropriately executed.

According to a twenty-sixth aspect of the present disclosure, in the encoder of any one of the first to twenty-fifth aspects, in encoding the bitstream, syntax information designating at least one of a number of pixels and a number of unit feature maps included in each layer may be encoded into the bitstream.

According to the twenty-sixth aspect, since the syntax information designating at least one of the number of pixels and the number of unit feature maps included in each layer is encoded into the bitstream, the decoding processing can be appropriately executed.

According to a twenty-seventh aspect of the present disclosure, in the encoder of the third aspect, in encoding the bitstream, syntax information designating at least one of a size and a number of encoded blocks included in each sectioned region may be encoded into the bitstream.

According to the twenty-seventh aspect, since the syntax information designating at least one of the size and the number of encoded blocks included in each sectioned region is encoded into the bitstream, the decoding processing can be appropriately executed.

According to a twenty-eighth aspect of the present disclosure, in the encoder of the sixth aspect, in encoding the bitstream, syntax information designating a number of pixels included in the pixel set may be encoded into the bitstream.

According to the twenty-eighth aspect, since the syntax information designating the number of pixels included in the pixel set is encoded into the bitstream, the decoding processing can be appropriately executed.

According to a twenty-ninth aspect of the present disclosure, in the encoder of the ninth aspect, in encoding the bitstream, syntax information designating the scan order may be encoded into the bitstream.

According to the twenty-ninth aspect, since the syntax information designating the scan order is encoded into the bitstream, the decoding processing can be appropriately executed.

According to a thirtieth aspect of the present disclosure, in the encoder of the fifteenth aspect, in encoding the bitstream, syntax information designating information designating a number of encoded blocks included in the one encoded block set and information designating a number of feature maps included in the one encoded block set may be encoded into the bitstream.

According to the thirtieth aspect, since the syntax information designating the information designating the number of encoded blocks included in one encoded block set and the information designating the number of feature maps included in one encoded block set is encoded into the bitstream, the decoding processing can be appropriately executed.

According to a thirty-first aspect of the present disclosure, in the encoder of the fourteenth or twenty-third aspect, in encoding the bitstream, syntax information designating the crop information may be encoded into the bitstream.

According to the thirty-first aspect, since the syntax information designating the crop information is encoded into the bitstream, the decoding processing can be appropriately executed.

According to a thirty-second aspect of the present disclosure, in the encoder of the twenty-fourth aspect, in encoding the bitstream, syntax information designating whether the unit feature map may be generated by using the first generation method or the second generation method may be encoded into the bitstream.

According to the thirty-second aspect, since the syntax information designating the first generation method or the second generation method is encoded into the bitstream, the decoding processing can be appropriately executed.

According to a thirty-third aspect of the present disclosure, a decoder includes circuitry, and a memory connected to the circuitry. The circuitry is configured to execute decoding, based on a bitstream, a picture in which a plurality of encoded blocks corresponding to a plurality of unit feature maps are arranged, the plurality of unit feature maps being generated based on a plurality of feature maps by packing a plurality of pixels included in at least one feature map into at least one encoded block, the plurality of feature maps being generated by means of a neural network having one or more layers, in the picture, an upper left boundary of each unit feature map being matched with an upper left boundary of any encoded block, acquiring the plurality of unit feature maps based on the picture, and reconstructing the plurality of feature maps based on the plurality of unit feature maps.

According to the thirty-third aspect, since the upper left boundary of each unit feature map is matched with the upper left boundary of any of the encoded blocks, the compression efficiency at the time of encoding can be improved.

According to a thirty-fourth aspect of the present disclosure, in the decoder of the thirty-third aspect, the picture may be a plurality of pictures, and a plurality of encoded blocks corresponding to a plurality of unit feature maps having different layers may be arranged in different pictures.

According to the thirty-fourth aspect, since pictures are different for each layer, the decoding processing can be facilitated.

According to a thirty-fifth aspect of the present disclosure, in the decoder of the thirty-third aspect, the picture may include a plurality of sectioned regions, and a plurality of encoded blocks corresponding to a plurality of unit feature maps having different layers may be arranged in different sectioned regions.

According to the thirty-fifth aspect, the sectioned regions are different for each layer, so that the decoding processing can be facilitated.

According to a thirty-sixth aspect of the present disclosure, in the decoder of the thirty-fifth aspect, the sectioned region may include a sub-picture, a tile, or a slice.

According to the thirty-sixth aspect, since the sub-picture, the tile, or the slice is different for each layer, the decoding processing can be facilitated.

According to a thirty-seventh aspect of the present disclosure, in the decoder of any one of the thirty-third to thirty-sixth aspects, in decoding the picture, syntax information or index information designating a generation method of the unit feature map and a generation method of the picture may be decoded from a supplemental enhancement information (SEI) region or another header region of the bitstream.

According to the thirty-seventh aspect, since the syntax information or the index information designating the generation method of the unit feature map and the generation method of the picture is encoded into the SEI region of the bitstream, the decoding processing can be facilitated.

According to a thirty-eighth aspect of the present disclosure, in the decoder of any one of the thirty-third to thirty-seventh aspects, one unit feature map may be generated by collecting a pixel set at a same position included in each feature map from a plurality of feature maps included in each layer, and packing a plurality of collected pixel sets in one encoded block.

According to the thirty-eighth aspect, it is possible to improve the compression efficiency when encoding a plurality of feature maps having low spatial correlation.

According to a thirty-ninth aspect of the present disclosure, in the decoder of the thirty-eighth aspect, the pixel set may be one pixel or two or more adjacent pixels.

According to the thirty-ninth aspect, since the size of the encoded block is appropriately set according to the number of pixels included in the pixel set, the compression efficiency at the time of encoding can be further improved.

According to a fortieth aspect of the present disclosure, in the decoder of the thirty-eighth or thirty-ninth aspect, a size of an encoded block in each layer may be set based on a number of feature maps included in each layer and a number of pixels included in the pixel set.

According to the fortieth aspect, since the size of the encoded block is appropriately set for each layer, the compression efficiency at the time of encoding can be further improved.

According to a forty-first aspect of the present disclosure, in the decoder of any one of the thirty-eighth to fortieth aspects, a plurality of collected pixel sets may be arranged in the encoded block in a designated scan order.

According to the forty-first aspect, since the unit feature map is appropriately stored in the encoded block, the decoding processing can be facilitated.

According to a forty-second aspect of the present disclosure, in the decoder of the forty-first aspect, in a case where the encoded block includes a surplus pixel in which no pixel set is stored, the surplus pixel may be padded using a specific value.

According to the forty-second aspect, since the surplus pixels of the encoded block are padded using the specific value, the compression efficiency at the time of encoding can be further improved.

According to a forty-third aspect of the present disclosure, in the decoder of any one of the thirty-eighth to forty-second aspects, a number of encoded blocks included in each layer may be set based on a number of pixels of a feature map included in each layer and a number of pixels included in the pixel set.

According to the forty-third aspect, since the number of encoded blocks included in each layer is appropriately set, the compression efficiency at the time of encoding can be further improved.

According to a forty-fourth aspect of the present disclosure, in the decoder of any one of the thirty-eighth to forty-third aspects, the picture may include a plurality of sectioned regions, a plurality of encoded blocks corresponding to a plurality of unit feature maps having different layers may be arranged in different sectioned regions, and in a case where each sectioned region includes a surplus encoded block in which the unit feature map is not stored, the surplus encoded block may be padded using a specific value.

According to the forty-fourth aspect, since the surplus encoded block of the picture is padded using the specific value, the compression efficiency at the time of encoding can be further improved.

According to a forty-fifth aspect of the present disclosure, in the decoder of any one of the thirty-eighth to forty-fourth aspects, the picture may include a plurality of sectioned regions, a plurality of encoded blocks corresponding to a plurality of unit feature maps having different layers may be arranged in different sectioned regions, at least one of a number of feature maps and a number of pixels included in each layer may differ according to a layer, a size of an encoded block included in each layer may be different according to a number of feature maps included in each layer, and a number of encoded blocks included in each layer may differ according to a number of pixels of a feature map included in each layer.

According to the forty-fifth aspect, since the size and the number of encoded blocks are different for each layer, the compression efficiency at the time of encoding can be further improved.

According to a forty-sixth aspect of the present disclosure, in the decoder of any one of the thirty-eighth to forty-fifth aspects, a surplus encoded block may be padded using a specific value in a case where the surplus encoded block in which the unit feature map is not stored is included in at least one region of an upper end, a lower end, a left end, and a right end of the picture, and the padded region may be designated by crop information of the picture.

According to the forty-sixth aspect, since the padded region is designated by the crop information of the picture, the decoding processing can be facilitated.

According to a forty-seventh aspect of the present disclosure, in the decoder of any one of the thirty-third to thirty-seventh aspects, one unit feature map may be generated by packing one feature map into one encoded block set or by packing a plurality of feature maps into one encoded block set.

According to the forty-seventh aspect, it is possible to improve the compression efficiency when encoding a plurality of feature maps having high spatial correlation.

According to a forty-eighth aspect of the present disclosure, in the decoder of the forty-seventh aspect, the encoded block set may be one encoded block or two or more adjacent encoded blocks.

According to the forty-eighth aspect, since the size of the encoded block set is appropriately set according to the number of pixels of the unit feature map, the compression efficiency at the time of encoding can be further improved.

According to a forty-ninth aspect of the present disclosure, in the decoder of the forty-seventh or forty-eighth aspect, a size of an encoded block set in each layer may be set based on a number of pixels of a feature map included in each layer.

According to the forty-ninth aspect, since the size of the encoded block set is appropriately set based on the number of pixels of the feature map, the compression efficiency at the time of encoding can be further improved.

According to a fiftieth aspect of the present disclosure, in the decoder of any one of the forty-seventh to forty-ninth aspects, in a case where the encoded block set includes a surplus pixel in which no unit feature map is stored, the surplus pixel may be padded using a specific value.

According to the fiftieth aspect, since the surplus pixels of the encoded block set are padded using the specific value, the compression efficiency at the time of encoding can be further improved.

According to a fifty-first aspect of the present disclosure, in the decoder of any one of the forty-seventh to fiftieth aspects, a number of encoded block sets in each layer may be set based on a number of feature maps included in each layer.

According to the fifty-first aspect, since the number of encoded block sets included in each layer is appropriately set, the compression efficiency at the time of encoding can be further improved.

According to a fifty-second aspect of the present disclosure, in the decoder of any one of the forty-seventh to fifty-first aspects, the picture may include a plurality of sectioned regions, a plurality of encoded block sets corresponding to a plurality of unit feature maps having different layers may be arranged in different sectioned regions, and in a case where each sectioned region includes a surplus encoded block set in which the unit feature map is not stored, the surplus encoded block set may be padded using a specific value.

According to the fifty-second aspect, since the surplus pixels in each sectioned region are padded using the specific value, the compression efficiency at the time of encoding can be further improved.

According to a fifty-third aspect of the present disclosure, in the decoder of any one of the forty-seventh to fifty-second aspects, the picture may include a plurality of sectioned regions, a plurality of encoded block sets corresponding to a plurality of unit feature maps having different layers may be arranged in different sectioned regions, at least one of a number of feature maps and a number of pixels included in each layer may differ according to a layer, a number of encoded block sets included in each layer may be different according to a number of feature maps included in each layer, and a size of an encoded block set included in each layer may differ according to a number of pixels of a feature map included in each layer.

According to the fifty-third aspect, since the number and size of encoded block sets are different for each layer, the compression efficiency at the time of encoding can be further improved.

According to a fifty-fourth aspect of the present disclosure, in the decoder of any one of the forty-seventh to fifty-third aspects, the picture may include a plurality of sectioned regions, a plurality of encoded block sets corresponding to a plurality of unit feature maps having different layers may be arranged in different sectioned regions, a size of an encoded block included in each layer may be common in a plurality of layers, a number of pixels of a feature map included in each layer may differ according to a layer, and a number of encoded blocks included in an encoded block set in each layer may differ according to a number of pixels of a feature map included in each layer.

According to the fifty-fourth aspect, since the number of encoded blocks included in an encoded block set is different for each layer, the compression efficiency at the time of encoding can be further improved.

According to a fifty-fifth aspect of the present disclosure, in the decoder of any one of the forty-seventh to fifty-fourth aspects, a surplus encoded block set may be padded using a specific value in a case where the surplus encoded block set in which the unit feature map is not stored is included in at least one region of an upper end, a lower end, a left end, and a right end of the picture, and the padded region may be designated by crop information of the picture.

According to the fifty-fifth aspect, since the padded region is designated by the crop information of the picture, the decoding processing can be facilitated.

According to a fifty-sixth aspect of the present disclosure, in the decoder of any one of the thirty-third to thirty-seventh aspects, a first generation method of generating one unit feature map by collecting a pixel set at a same position included in each feature map from a plurality of feature maps included in each layer and packing a plurality of collected pixel sets in one encoded block, and a second generation method of generating one unit feature map by packing one feature map into one encoded block set or by packing a plurality of feature maps into one encoded block set may be switched in units of pictures or in units of layers.

According to the fifty-sixth aspect, since the first generation method and the second generation method are appropriately switched in units of pictures or in units of layers according to the input image, the compression efficiency at the time of encoding can be further improved.

According to a fifty-seventh aspect of the present disclosure, in the decoder of any one of the thirty-third to fifty-sixth aspects, in decoding the picture, syntax information designating a number of the plurality of layers may be decoded from the bitstream.

According to the fifty-seventh aspect, the decoding processing can be appropriately executed based on the syntax information designating the number of layers.

According to a fifty-eighth aspect of the present disclosure, in the decoder of any one of the thirty-third to fifty-seventh aspects, in decoding the picture, syntax information designating at least one of a number of pixels and a number of unit feature maps included in each layer may be decoded from the bitstream.

According to the fifty-eighth aspect, the decoding processing can be appropriately executed based on the syntax information designating at least one of the number of pixels and the number of unit feature maps included in each layer.

According to a fifty-ninth aspect of the present disclosure, in the decoder of the thirty-fifth aspect, in decoding the picture, syntax information designating at least one of a size and a number of encoded blocks included in each sectioned region may be decoded from the bitstream.

According to the fifty-ninth aspect, the decoding processing can be appropriately executed based on the syntax information designating at least one of the size and the number of the encoded blocks included in each of the sectioned regions.

According to a sixtieth aspect of the present disclosure, in the decoder of the thirty-eighth aspect, in decoding the picture, syntax information designating a number of pixels included in the pixel set may be decoded from the bitstream.

According to the sixtieth aspect, the decoding processing can be appropriately executed based on the syntax information designating the number of pixels included in the pixel set.

According to a sixty-first aspect of the present disclosure, in the decoder of the forty-first aspect, in decoding the picture, syntax information designating the scan order may be decoded from the bitstream.

According to the sixty-first aspect, the decoding processing can be appropriately executed based on the syntax information designating the scan order.

According to a sixty-second aspect of the present disclosure, in the decoder of the forty-seventh aspect, in decoding the picture, syntax information designating information designating a number of encoded blocks included in the one encoded block set and information designating a number of feature maps included in the one encoded block set may be decoded from the bitstream.

According to the sixty-second aspect, the decoding processing can be appropriately executed based on the syntax information designating the information designating the number of encoded blocks included in one encoded block set and the information designating the number of feature maps included in one encoded block set.

According to a sixty-third aspect of the present disclosure, in the decoder of the forty-sixth or fifty-fifth aspect, in decoding the picture, syntax information designating the crop information may be decoded from the bitstream.

According to the sixty-third aspect, the decoding processing can be appropriately executed based on the syntax information designating the crop information.

According to a sixty-fourth aspect of the present disclosure, in the decoder of the fifty-sixth aspect, in decoding the picture, syntax information designating whether the unit feature map is generated by using the first generation method or the second generation method may be decoded from the bitstream.

According to the sixty-fourth aspect, the decoding processing can be appropriately executed based on the syntax information designating the first generation method or the second generation method.

According to a sixty-fifth aspect of the present disclosure, an encoding method causes an encoder to execute generating a plurality of feature maps by means of a neural network having one or more layers based on an input image to be processed, generating a plurality of unit feature maps based on the plurality of feature maps by packing a plurality of pixels included in at least one feature map into at least one encoded block, generating a picture by arranging a plurality of encoded blocks corresponding to the plurality of unit feature maps, generating a bitstream by encoding the picture, and matching, in the generating of the unit feature maps, an upper left boundary of each unit feature map with an upper left boundary of any encoded block.

According to the sixty-fifth aspect, since the upper left boundary of each unit feature map is matched with the upper left boundary of any encoded block, the compression efficiency at the time of encoding can be improved.

According to a sixty-sixth aspect of the present disclosure, a decoding method causes a decoder to execute decoding, based on a bitstream, a picture in which a plurality of encoded blocks corresponding to a plurality of unit feature maps are arranged, the plurality of unit feature maps being generated based on a plurality of feature maps by packing a plurality of pixels included in at least one feature map into at least one encoded block, the plurality of feature maps being generated by means of a neural network having one or more layers, in the picture, an upper left boundary of each unit feature map being matched with an upper left boundary of any encoded block, acquiring the plurality of unit feature maps based on the picture, and reconstructing the plurality of feature maps based on the plurality of unit feature maps.

According to the sixty-sixth aspect, since the upper left boundary of each unit feature map is matched with the upper left boundary of any of the encoded blocks, the compression efficiency at the time of encoding can be improved.

### Embodiments of Present Disclosure

Embodiments of the present disclosure will be described below in detail with reference to the drawings. Elements denoted with the same reference symbol in different drawings represent the same or corresponding elements.

Note that each embodiment described below shows one specific example of the present disclosure. The numerical values, shapes, constituent elements, steps, orders of the steps, and the like of the following embodiments are merely examples, and do not intend to limit the present disclosure. A constituent element not described in an independent claim representing the highest concept among constituent elements in the embodiments below is described as an arbitrary constituent element. In all embodiments, respective items of content can be combined.

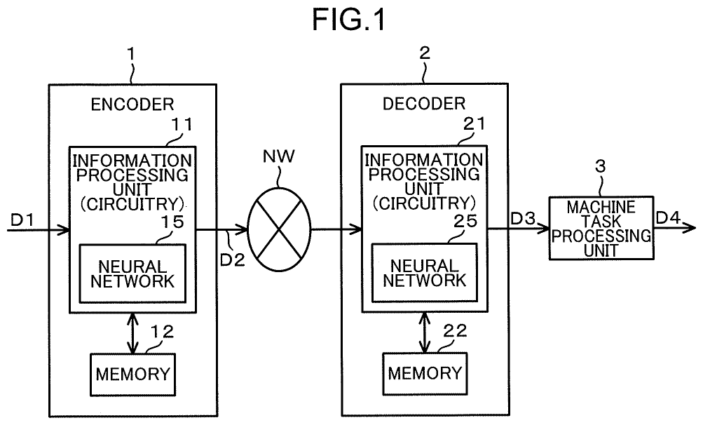

FIG. 1 is a diagram illustrating, in a simplified manner, the configuration of an image processing system according to an embodiment of the present disclosure. The image processing system includes an encoder 1, a transmission channel NW, a decoder 2, and a machine task processing unit 3.

The encoder 1 is configured to include an information processing unit 11 and a memory 12 connected to the information processing unit 11. However, the memory 12 may be included in the information processing unit 11. The information processing unit 11 is circuitry that performs various types of information processing, and includes a processor such as a CPU or a GPU. The information processing includes processing using a neural network 15 for a machine task executed by the machine task processing unit 3. The neural network 15 includes, for example, a first neural network (feature pyramid network) for generating a plurality of feature maps in Faster-RCNN. The memory 12 includes a semiconductor memory such as a ROM or a RAM, a magnetic disk, or an optical disk. The memory 12 stores information necessary for the processor to execute processing. For example, the memory 12 stores an input image D1 of a processing target. Furthermore, the memory 12 stores a program for causing the processor to execute information processing. The encoder 1 generates a bitstream D2 based on the input image D1, and transmits the bitstream D2 that is generated to the decoder 2 via the transmission channel NW. Details of the processing content executed by the encoder I will be described later.

The transmission channel NW is the Internet, a wide area network (WAN), a local area network (LAN), or an arbitrary combination of them. The transmission channel NW may be a public network or the like, or may be a private network in which secure communication is ensured by access restriction. The transmission channel NW is not necessarily limited to a bidirectional communication network, and may be a unidirectional communication network for transmitting a broadcast wave such as terrestrial digital broadcasting or satellite broadcasting.

The transmission channel NW may be a recording medium such as a digital versatile disc (DVD) or a blue-ray disc (BD) on which the bitstream D2 is recorded.

The decoder 2 is configured to include an information processing unit 21 and a memory 22 connected to the information processing unit 21. However, the memory 22 may be included in the information processing unit 21. The information processing unit 21 is circuitry that performs various types of information processing, and includes a processor such as a CPU or a GPU. The information processing includes processing using a neural network 25 for a machine task executed by the machine task processing unit 3. The neural network 25 includes, for example, a second neural network (region proposal network) for extracting a region of interest (ROI) in Faster-RCNN. The memory 22 includes a semiconductor memory such as a ROM or a RAM, a magnetic disk, or an optical disk. The memory 22 stores information necessary for the processor to execute processing. For example, the memory 22 stores the bitstream D2 received from the encoder 1. Furthermore, the memory 22 stores a program for causing the processor to execute information processing. The decoder 2 reconstructs a plurality of feature maps based on the bitstream D2 received from the encoder 1, performs processing of the neural network 25 on the plurality of reconstructed feature maps, and inputs data D3 including information of the extracted ROI region to the machine task processing unit 3. Details of the processing content executed by the decoder 2 will be described later.

The machine task processing unit 3 executes a machine task based on the data D3 input from the decoder 2, and outputs data D4 including an inference result of the machine task and the like. The machine task is realized by a combination of the neural network 15, the neural network 25, and the machine task processing unit 3, and includes, for example, object detection, object segmentation, object tracking, action recognition, or pose estimation.

In the Faster RCNN, the encoder 1 performs convolution processing on the input image D1 to be processed using the neural network 15, thereby generating a plurality of feature maps having different sizes for each layer. The plurality of layers includes, for example, a P2 layer which is the highest layer, a P3 layer and a P4 layer which are intermediate layers, and a P5 layer which is the lowest layer. Note that the neural network 15 may have one or more layers. The decoder 2 and the machine task processing unit 3 extract the ROI region from the feature map by applying the RP model using the neural network 25 to the feature map, and perform image recognition on the extracted ROI region.

### (Processing of Encoding Device 1)

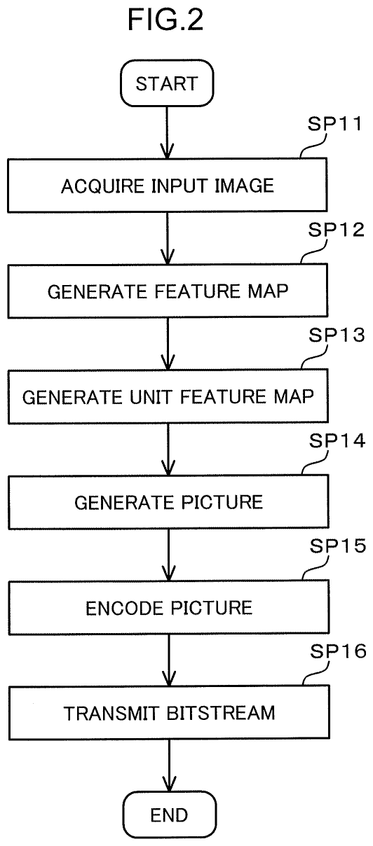

FIG. 2 is a flowchart illustrating processing executed by the information processing unit 11 of the encoder 1.

First, in step SP11, the information processing unit 11 acquires an input image D1 of a moving image to be processed from an imaging device such as a camera. However, the input image D1 is not limited to a moving image, and may be a still image.

Next, in step SP12, the information processing unit 11 generates a plurality of feature maps FM by the neural network 15 having a plurality of layers based on the input image D1 acquired in step SP11.

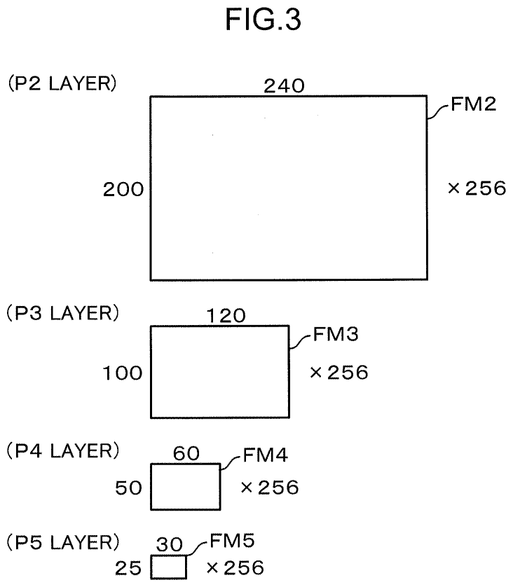

FIG. 3 is a diagram illustrating an example of a plurality of feature maps FM (FM2 to FM5). The information processing unit 11 generates 256 feature maps FM2 of 240 pixels wide×200 pixels high in the P2 layer, 256 feature maps FM3 of 120 pixels wide×100 pixels high in the P3 layer, 256 feature maps FM4 of 60 pixels wide×50 pixels high in the P4 layer, and 256 feature maps FM5 of 30 pixels wide×25 pixels high in the P5 layer. However, the number of layers and the size and number of feature maps are not limited to this example.

Next, in step SP13, the information processing unit 11 generates a plurality of unit feature maps UFM (UFM2 to UFM5) based on the plurality of feature maps FM (FM2 to FM5) generated in step SP12. The unit feature map means an intermediate feature map generated by packing a plurality of pixel sets G included in at least one feature map FM in at least one encoded block B. The encoded block B includes a coding unit (CU) or a coding tree unit (CTU) which is a unit of coding processing.

Next, in step SP14, the information processing unit 11 generates a picture P by arranging a plurality of encoded blocks B corresponding to the plurality of unit feature maps UFM generated in step SP13 in a frame.

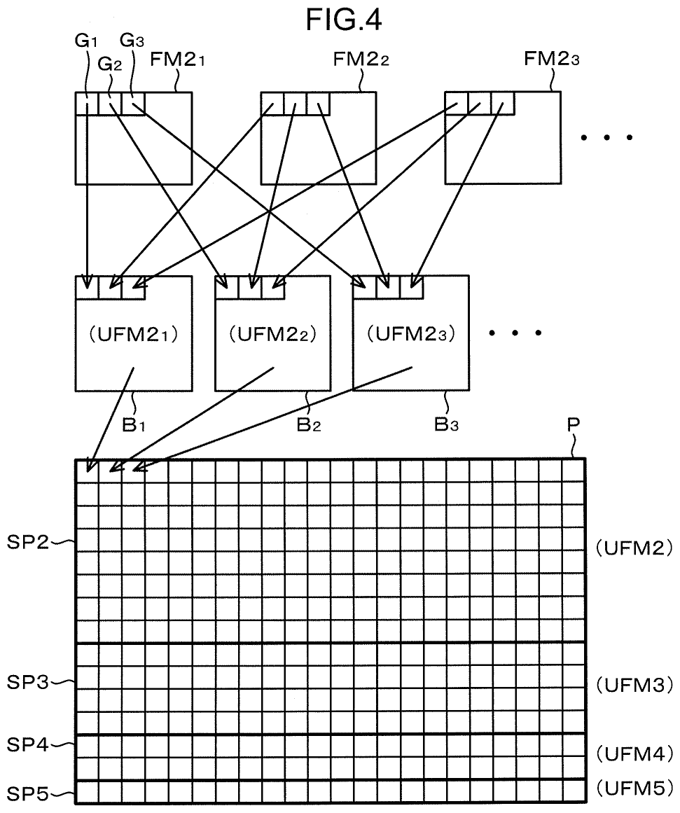

FIG. 4 is a diagram schematically illustrating generation processing of a unit feature map UFM and generation processing of a picture P. In each layer, the information processing unit 11 generates one unit feature map UFM by collecting pixel sets G at the same position included in each feature map FM from the plurality of feature maps FM, and packing the plurality of collected pixel sets G in one encoded block B. A generation method of such a unit feature map is referred to as a “generation method with remapping” in the present specification.

Furthermore, the information processing unit 11 sets the size of the encoded block B in each layer based on the number of feature maps FM included in each layer and the number of pixels included in the pixel set G. In the example illustrated in FIG. 4, the pixel set G includes one pixel, the number of feature maps FM included in each layer is 256, and the size of the encoded block B is 256 pixels of 16 pixels wide×16 pixels high.

For example, the information processing unit 11 collects the pixel set G₁ of the first row and the first column included in each of the feature maps FM2₁ to FM2₂₅₆ from the 256 feature maps FM2₁ to FM2₂₅₆ in the P2 layer, and packs the collected 256 pixel sets G₁ in the encoded block B₁ to generate the unit feature map UFM2₁. Furthermore, the information processing unit 11 collects the pixel set G₂ in the first row and the second column included in each of the feature maps FM2₁ to FM2₂₅₆ from the 256 feature maps FM2₁ to FM2₂₅₆ in the P2 layer, and packs the collected 256 pixel sets G₂ in the encoded block B₂, thereby generating the unit feature map UFM2₂.

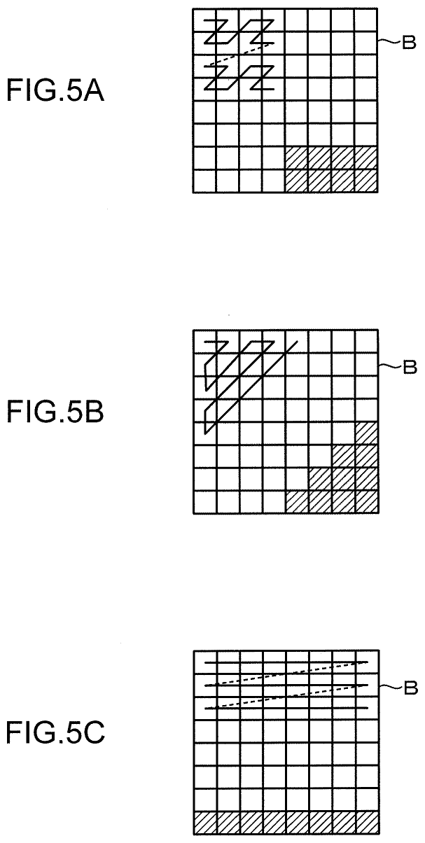

FIGS. 5A to 5C are diagrams illustrating, in a simplified manner, a method of packing the pixel set G into the encoded block B. The information processing unit 11 designates the scan order when arranging the plurality of collected pixel sets G in the encoded block B. The information processing unit 11 may arrange the pixel set G in the encoded block B by Z scanning as illustrated in FIG. 5A. Alternatively, the information processing unit 11 may arrange the pixel sets G in the encoded block B by zigzag scanning as illustrated in FIG. 5B. Alternatively, the information processing unit 11 may arrange the pixel set G in the encoded block B by raster scan as illustrated in FIG. 5C.

As illustrated in FIGS. 5A to 5C, the information processing unit 11 arranges the plurality of collected pixel sets G in order from the upper left boundary (first row and first column) of the encoded block B. As a result, the upper left boundary of the unit feature map UFM is matched with the upper left boundary of the encoded block B. The upper left boundary means a start point of the scan order when the plurality of pixel sets G are arranged in the encoded block B. Therefore, depending on the start point of the scan order, the upper left may be the upper right, the lower left, or the lower right.

Furthermore, in a case where the encoded block B includes a surplus pixel in which the pixel set G is not stored, the information processing unit 11 pads the surplus pixel using a specific value. In FIGS. 5A to 5C, hatched pixels correspond to surplus pixels. The specific value may be all “0”, all “1”, or any other value.

As illustrated in FIG. 4, the picture P includes a plurality of sectioned regions. The sectioned region includes a sub-picture, a tile, or a slice. In the example illustrated in FIG. 4, the picture P includes a sub-picture SP2 corresponding to the P2 layer, a sub-picture SP3 corresponding to the P3 layer, a sub-picture SP4 corresponding to the P4 layer, and a sub-picture SP5 corresponding to the P5 layer. The information processing unit 11 sets the number of encoded blocks B included in each layer based on the number of pixels of the feature maps FM2 to FM5 included in each layer and the number of pixels included in the pixel set G. In the example illustrated in FIG. 3, the number of pixels of the feature map FM2 is 240 pixels wide×200 pixels high, the number of pixels of the feature map FM3 is 120 pixels wide×100 pixels high, the number of pixels of the feature map FM4 is 60 pixels wide×50 pixels high, and the number of pixels of the feature map FM5 is 30 pixels wide×25 pixels high. In this case, the information processing unit 11 sets the number of encoded blocks B included in the sub-picture SP2 to 240×200=48000, sets the number of encoded blocks B included in the sub-picture SP3 to 120×100=12000, sets the number of encoded blocks B included in the sub-picture SP4 to 60×50=3000, and sets the number of encoded blocks B included in the sub-picture SP5 to 30×25=750.

In generating the picture P, the information processing unit 11 arranges a plurality of encoded blocks B corresponding to a plurality of unit feature maps UFM having different layers in different sectioned regions. In the example illustrated in FIG. 4, the information processing unit 11 arranges the encoded block B storing a unit feature map UFM2 of the P2 layer in the sub-picture SP2, arranges the encoded block B storing a unit feature map UFM3 of the P3 layer in the sub-picture SP3, arranges the encoded block B storing a unit feature map UFM4 of the P4 layer in the sub-picture SP4, and arranges the encoded block B storing a unit feature map UFM5 of the P5 layer in the sub-picture SP5.

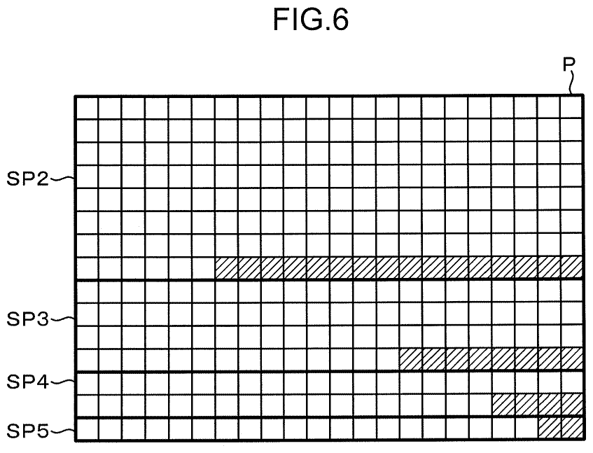

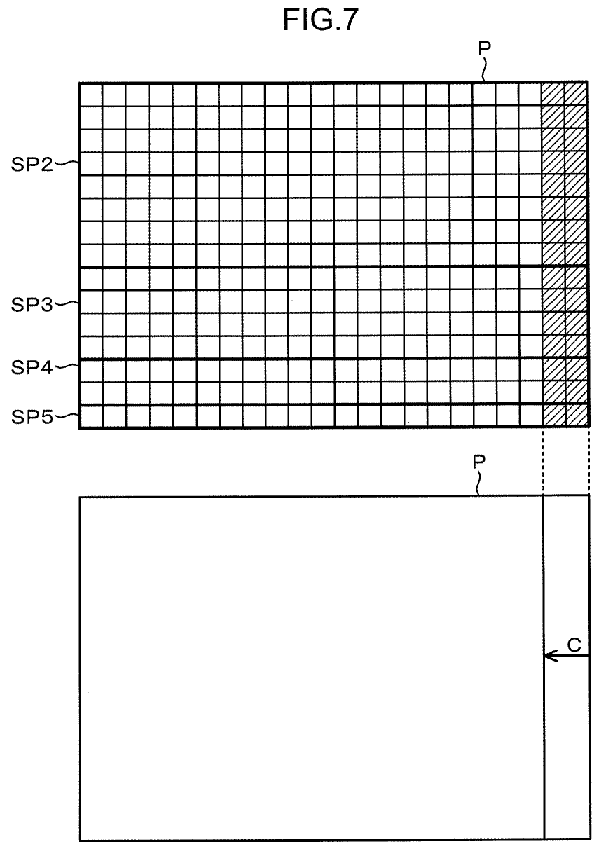

FIG. 6 is a diagram illustrating an example of a picture P in a simplified manner. In a case where each of the sub-pictures SP2 to SP5 includes a surplus encoded block in which the unit feature maps UFM2 to UFM5 are not stored, the information processing unit 11 pads the surplus encoded block using a specific value. The hatched encoded block in FIG. 6 corresponds to a surplus encoded block. The specific value may be all “0”, all “1”, or any other value. FIG. 7 is a diagram illustrating another example of the picture P in a simplified manner.

The information processing unit 11 may aggregate and arrange the surplus encoded blocks in at least one rectangular region of the upper end, the lower end, the left end, and the right end of the picture P. In this case, the information processing unit 11 may designate the rectangular region including the surplus encoded block padded using the specific value by crop information C indicating the offset value from the edge side of the picture P.

Referring to FIG. 2, next, in step SP15, the information processing unit 11 encodes the picture P generated in step SP14 into the bitstream D2 by an arbitrary moving image encoding method such as VVC or HEVC.

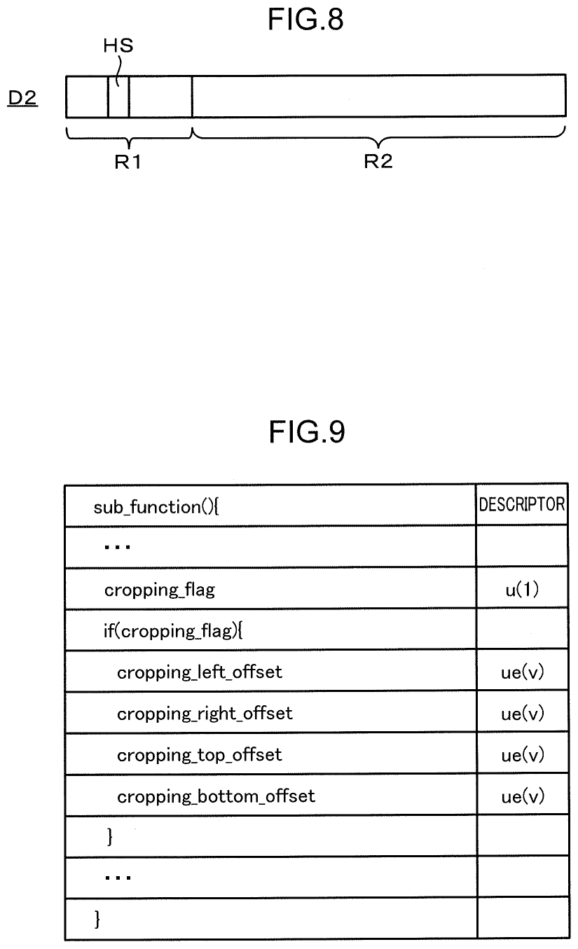

FIG. 8 is a diagram schematically illustrating the bitstream D2. The bitstream D2 contains a header region R1 and a payload region R2. The information processing unit 11 encodes the picture P in the payload region R2. In addition, the information processing unit 11 encodes syntax information designating a generation method of the unit feature map UFM and a generation method of the picture P into a predetermined location of the header region R1. The predetermined location is, for example, a supplemental enhancement information (SEI) region for storing additional information. The predetermined location may be VPS, SPS, PPS, PH, SH, APS, or a tile header.

Next, in step SP16, the information processing unit 11 transmits the bitstream D2 generated in step SP15 to the decoder 2 via the transmission channel NW.

FIG. 9 is a diagram illustrating a first example of the syntax information. The syntax information corresponds to the crop information C described above, and includes information designating an offset value from an edge side of the picture P.

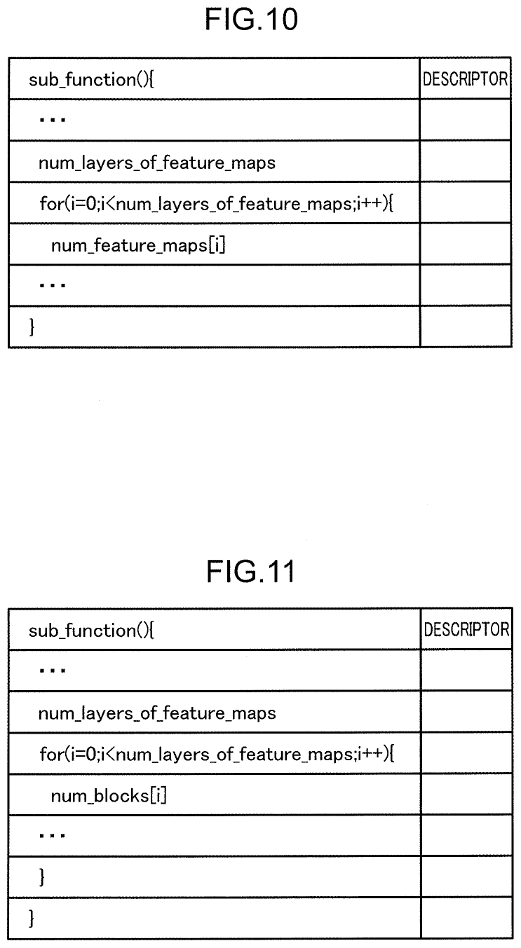

FIG. 10 is a diagram illustrating a second example of the syntax information. The syntax information includes information designating the number of layers of a plurality of layers and information designating the number of feature maps FM or unit feature maps UFM in each layer.

FIG. 11 is a diagram illustrating a third example of the syntax information. The syntax information includes information designating the number of encoded blocks B in each layer.

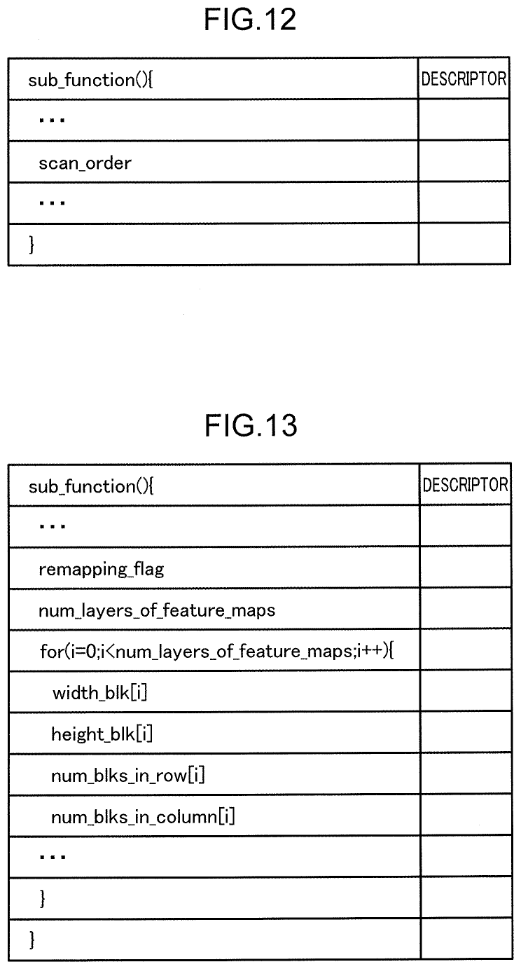

FIG. 12 is a diagram illustrating a fourth example of the syntax information. The syntax information includes information designating a scan order.

FIG. 13 is a diagram illustrating a fifth example of the syntax information. The syntax information includes information designating the presence or absence of remapping and information designating the size and the number of encoded blocks B in each layer.

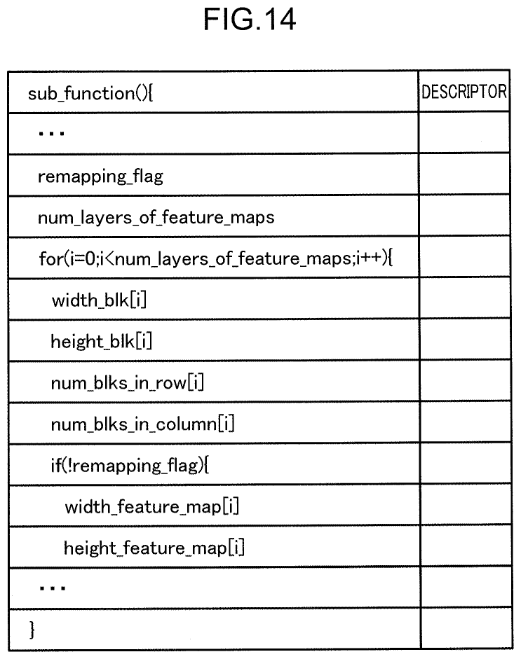

FIG. 14 is a diagram illustrating a sixth example of the syntax information. The syntax information includes information designating the size of the unit feature map UFM in each layer.

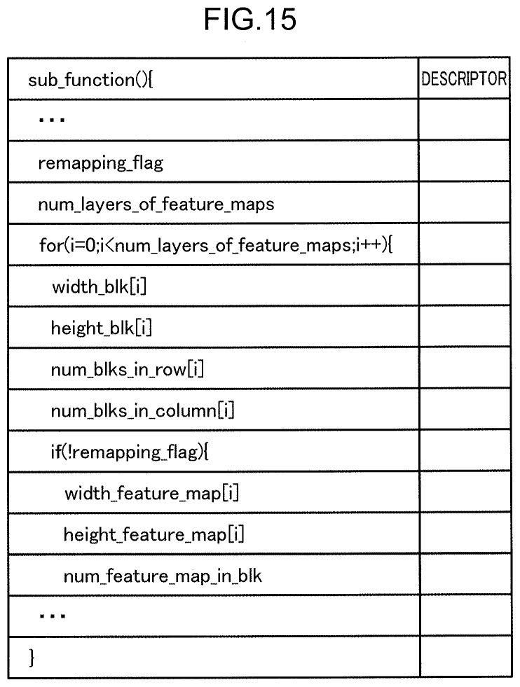

FIG. 15 is a diagram illustrating a seventh example of the syntax information. The syntax information includes information designating the number of feature maps FM included in one unit feature map UFM in a case where one unit feature map UFM includes a plurality of feature maps FM.

In a case where the product of the size (width_blk[i]) of the encoded block B in the horizontal direction and the number (num_blks_in_row[i]) of the encoded blocks B in the horizontal direction is smaller than the width of the picture P, and thus there is a surplus region in the horizontal direction, the encoder 1 may pad the surplus region in the horizontal direction, and the decoder 2 may ignore the surplus region in the horizontal direction after decoding. Similarly, in a case where the product of the size (height_blk[i]) of the encoded block B in the vertical direction and the number (num_blks_in_column[i]) of the encoded blocks B in the vertical direction is smaller than the height of the picture P, and thus there is a surplus region in the vertical direction, the encoder 1 may pad the surplus region in the vertical direction, and the decoder 2 may ignore the surplus region in the vertical direction after decoding. The surplus regions in the horizontal direction and the vertical direction may be designated by the syntax information of the crop illustrated in FIG. 9.

Further, in a case where the product of the size (width_blk[i]) of the encoded block B in the horizontal direction and the number (num_blks_in_row[i]) of the encoded blocks B in the horizontal direction is smaller than the width of the sectioned region allocated to each layer, and thus there is a surplus region in the horizontal direction, the encoder 1 may pad the surplus region in the horizontal direction, and the decoder 2 may ignore the surplus region in the horizontal direction after decoding. Similarly, in a case where the product of the size (height_blk[i]) of the encoded block B in the vertical direction and the number (num_blks_in_column[i]) of the encoded blocks B in the vertical direction is smaller than the height of the sectioned region allocated to each layer, and thus there is a surplus region in the vertical direction, the encoder 1 may pad the surplus region in the vertical direction, and the decoder 2 may ignore the surplus region in the vertical direction after decoding.

Further, in a case where the product of the number of encoded blocks B in the horizontal direction (num_blks_in_row[i]) and the number of encoded blocks B in the vertical direction (num_blks_in_column[i]) in each layer is smaller than the total number of sectioned regions allocated to each layer and there is a surplus block, the encoder 1 may pad the surplus block, and the decoder 2 may ignore the surplus block after decoding.

In addition, in a case where the product of the size in the horizontal direction (width_blk[i]) and the size in the vertical direction (height_blk[i]) of the encoded block B in each layer is larger than the number of feature maps FM in each layer with remapping (remapping_flag=1), and thus there is a surplus pixel, the encoder 1 may pad the surplus pixel, and the decoder 2 may ignore the surplus pixel after decoding.

In addition, in a case where the product of the size in the horizontal direction (width_blk[i]) and the size in the vertical direction (height_blk[i]) of the encoded block B in each layer is larger than the product of the size in the horizontal direction (width_feature_map[i]) and the size in the vertical direction (height_feature_map[i]) of the feature map FM in each layer without remapping (remapping_flag=0), and thus there is a surplus pixel, the encoder 1 may pad the surplus pixel, and the decoder 2 may ignore the surplus pixel after decoding.

In addition, in a case where the product of the size in the horizontal direction (width_feature_map[i]), the size in the vertical direction (height_feature_map[i]), and the number (num_feature_map_in_blk) of the feature map FM in each layer is smaller than the product of the size in the horizontal direction (width_blk[i]) and the size in the vertical direction (height_blk[i]) of the encoded block B in each layer without remapping (remapping_flag=0), and thus there is a surplus pixel, the encoder 1 may pad the surplus pixel, and the decoder 2 may ignore the surplus pixel after decoding.

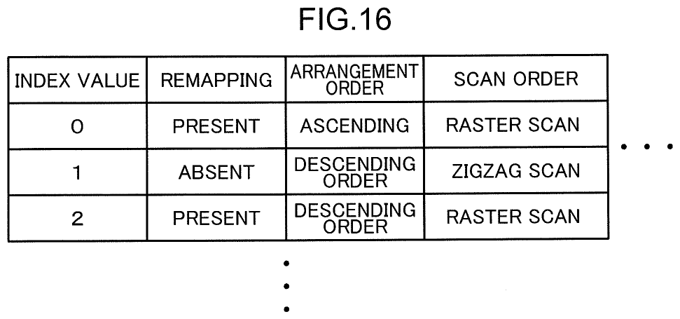

FIG. 16 is a diagram illustrating index information in a simplified manner. The index information is a lookup table or the like, and includes a plurality of items such as an index value, remapping, arrangement order, or scan order. In the item of the index value, a serial number is written. In the item of remapping, the presence or absence of remapping is described. In the item of the arrangement order, the arrangement order (ascending order or descending order) of the layers when the plurality of encoded blocks B corresponding to the plurality of layers are arranged in the picture P is described. In the item of the scan order, a scan order such as raster scan, zigzag scan, or raster scan is described. The encoder 1 and the decoder 2 may share the same index information, and the information processing unit 11 may encode the index value included in the index information into the bitstream D2 instead of the syntax information.

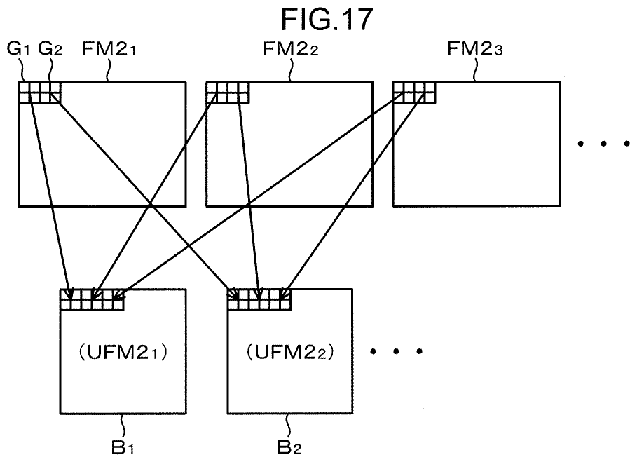

FIG. 17 is a diagram schematically illustrating a modification of the generation processing of the unit feature map UFM. In the example illustrated in FIG. 4, the pixel set G includes one pixel, but as illustrated in FIG. 17, the pixel set G may include a plurality of adjacent pixels (four pixels in two rows and two columns in this example). The information processing unit 11 designates the number of pixels included in the pixel set G by syntax information or index information.

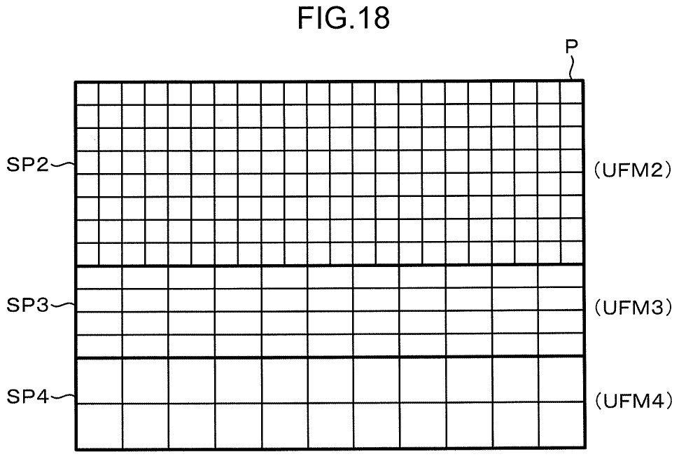

FIG. 18 is a diagram schematically illustrating a modification of the generation processing of a picture P. In the example illustrated in FIG. 4, the picture P includes the sub-pictures SP2 to SP5 of four layers. However, as illustrated in FIG. 18, the picture P may include the sub-pictures SP2 to SP4 of three layers. Furthermore, in the example illustrated in FIG. 4, the size of the encoded block B included in each layer is common, but the size of the encoded block B may be different for each layer as illustrated in FIG. 18. The information processing unit 11 sets the size of the encoded block B in each layer based on the number of feature maps FM included in each layer and the number of pixels included in the pixel set G. Furthermore, the information processing unit 11 sets the number of encoded blocks B included in each layer based on the number of pixels of the feature maps FM included in each layer and the number of pixels included in the pixel set G. The size of the encoded block B included in each layer differs according to the number of feature maps FM included in each layer. In addition, the number of encoded blocks B included in each layer differs according to the number of pixels of the feature maps FM included in each layer.

For example, the information processing unit 11 generates 256 feature maps FM2 of 136 pixels wide×76 pixels high in the P2 layer, 512 feature maps FM3 of 68 pixels wide×38 pixels high in the P3 layer, and 1024 feature maps FM4 of 34 pixels wide×19 pixels high in the P4 layer. In a case where the number of pixels included in the pixel set G is one pixel, for example, the sub-picture SP2 includes 136×76=10336 encoded blocks B of 16 pixels wide×16 pixels high=256 pixels, the sub-picture SP3 includes 68×38=2584 encoded blocks B of 32 pixels wide×16 pixels high=512 pixels, and the sub-picture SP4 includes 34×19=646 encoded blocks B of 32 pixels wide×32 pixels high=1024 pixels.

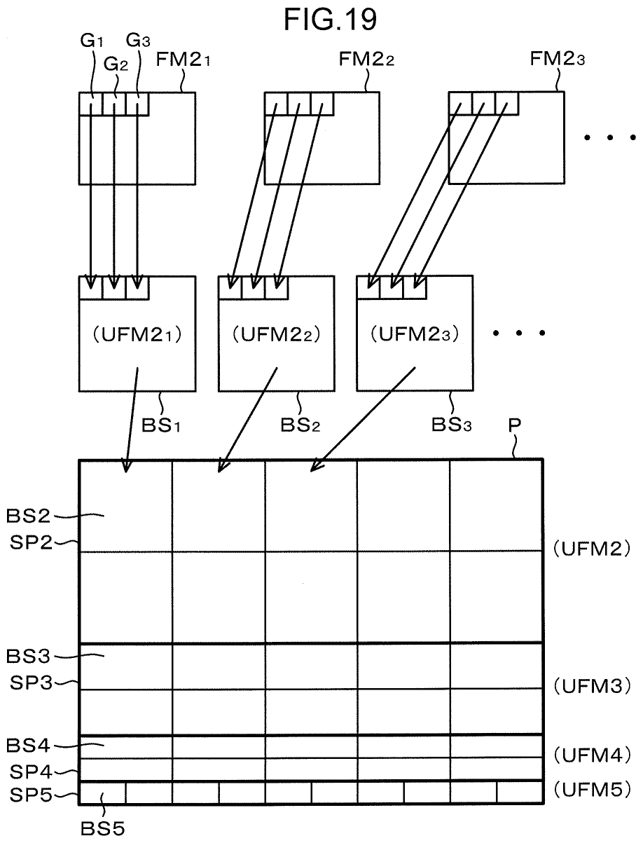

FIG. 19 is a diagram schematically illustrating a modification of the generation processing of the unit feature map UFM and the generation processing of the picture P. The information processing unit 11 generates one unit feature map UFM by packing one feature map FM in one encoded block set BS or packing a plurality of feature maps FM in one encoded block set BS in each layer. A generation method of such a unit feature map is referred to as a “generation method without remapping” in the present specification. The encoded block set BS is one encoded block B or two or more adjacent encoded blocks B.

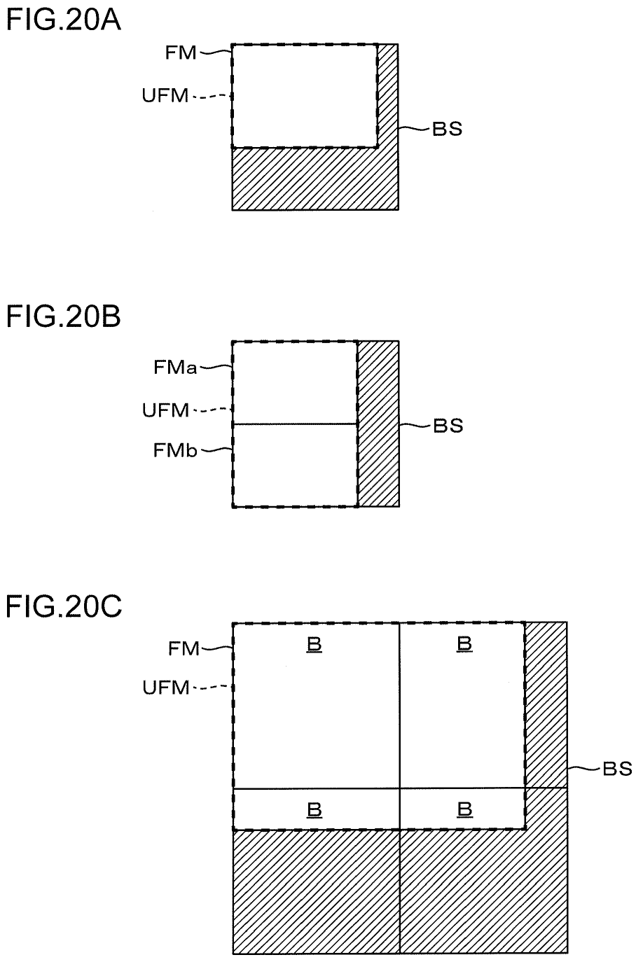

FIGS. 20A to 20C are diagrams illustrating examples of the unit feature map UFM and the encoded block set BS.

In the example illustrated in FIG. 20A, the encoded block set BS includes one encoded block B, and one feature map FM is stored in the encoded block set BS, whereby one unit feature map UFM is generated.

In the example illustrated in FIG. 20B, the encoded block set BS includes one encoded block B, and a plurality of feature maps FM (two feature maps FMa and FMb in this example) are stored in the encoded block set BS, so that one unit feature map UFM is generated.

In the example illustrated in FIG. 20C, the encoded block set BS includes a plurality of (four in this example) encoded blocks B, and one feature map FM is stored in the encoded block set BS, whereby one unit feature map UFM is generated.

The information processing unit 11 designates the number of encoded blocks B included in one encoded block set BS and the number of feature maps FM included in one encoded block set BS by syntax information or index information.

Furthermore, in a case where the encoded block set BS includes a surplus pixel in which the pixel set G of the unit feature map UFM is not stored, the information processing unit 11 pads the surplus pixel using a specific value. Pixels hatched in FIGS. 20A to 20C correspond to surplus pixels. The specific value may be all “0”, all “1”, or any other value.

The information processing unit 11 sets the size of the encoded block set BS in each layer within a range allowed by the codec standard based on the number of pixels of the feature map FM included in each layer. In the example illustrated in FIG. 3, the number of pixels of the feature map FM2 is 240 pixels wide×200 pixels high, the number of pixels of the feature map FM3 is 120 pixels wide×100 pixels high, the number of pixels of the feature map FM4 is 60 pixels wide×50 pixels high, and the number of pixels of the feature map FM5 is 30 pixels wide×25 pixels high. In this case, for example, the information processing unit 11 sets the size of the encoded block set BS2 of the P2 layer to 256 pixels wide×256 pixels high, sets the size of the encoded block set BS3 of the P3 layer to 128 pixels wide×128 pixels high, sets the size of the encoded block set BS4 of the P4 layer to 64 pixels wide×64 pixels high, and sets the size of the encoded block set BS5 of the P5 layer to 32 pixels wide×32 pixels high.

For example, in the P2 layer, the information processing unit 11 generates the unit feature map UFM2₁ by packing all the pixel sets G included in the feature map FM2₁ into the encoded block set BS1. Furthermore, the information processing unit 11 generates the unit feature map UFM2₂ by packing all the pixel sets G included in the feature map FM22 into the encoded block set BS2.

As illustrated in FIG. 19, the information processing unit 11 arranges the plurality of pixel sets G in order from the upper left boundary of the encoded block set BS. As a result, the upper left boundary of the unit feature map UFM is matched with the upper left boundary of the encoded block set BS.

The picture P includes a plurality of sub-pictures SP2 to SP5. The information processing unit 11 sets the number of encoded block sets BS included in each layer based on the number of feature maps FM included in each layer.

In the example illustrated in FIG. 3, the number of feature maps FM2 to FM5 is 256. Therefore, the information processing unit 11 sets the number of encoded block sets BS included in each layer to 256.

Note that, similarly to the above, in a case where each of the sub-pictures SP2 to SP5 includes a surplus encoded block set BS in which the unit feature maps UFM2 to UFM5 are not stored, the information processing unit 11 may pad the surplus encoded block set BS using a specific value. Furthermore, the information processing unit 11 may aggregate and arrange the surplus encoded block sets BS in at least one rectangular region of the upper end, the lower end, the left end, and the right end of the picture P. In this case, the information processing unit 11 may designate the rectangular region including the surplus encoded block set BS padded using the specific value by crop information C indicating the offset value from the edge side of the picture P.

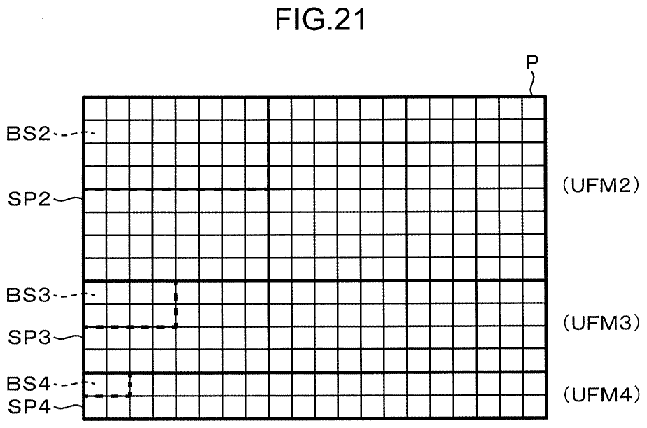

FIG. 21 is a diagram illustrating another example of the picture P in a simplified manner. The size of the encoded block B included in each layer is common to a plurality of layers. The information processing unit 11 varies the number of encoded blocks B included in the encoded block set BS in each layer according to the number of pixels of the feature maps FM2 to FM5 included in each layer.

For example, in a case where the size of the encoded block B is 16 pixels wide×16 pixels high, and the size of the feature map FM2 is 240 pixels wide×200 pixels high, the information processing unit 11 includes the encoded blocks B of 15 wide×13 high=195 in the encoded block set BS2. Furthermore, for example, in a case where the size of the encoded block B is 16 pixels wide×16 pixels high, and the size of the feature map FM3 is 120 pixels wide×100 pixels high, the information processing unit 11 includes the encoded blocks B of 8 wide×7 high=56 in the encoded block set BS3.

Furthermore, the information processing unit 11 may switch between the generation method with remapping (first generation method) and the generation method without remapping (second generation method) in units of pictures P or in units of layers.

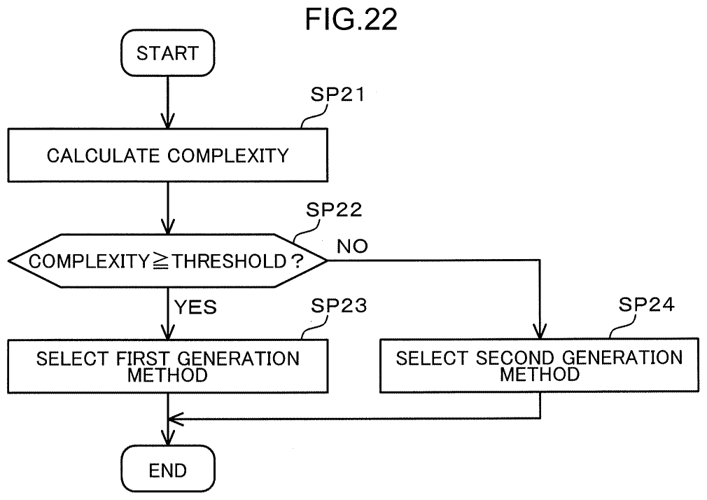

FIG. 22 is a flowchart illustrating an example of switching processing between the first generation method and the second generation method in units of pictures P.

First, in step SP21, the information processing unit 11 calculates the complexity of the input image D1. The complexity is, for example, a sum of absolute differences of pixel values.

Next, in step SP22, the information processing unit 11 determines whether the complexity calculated in step SP21 is equal to or greater than a predetermined threshold.

In a case where the complexity is equal to or greater than the threshold (step SP22: YES), next in step SP23, the information processing unit 11 selects the first generation method with remapping for the input image D1.

In a case where the complexity is less than the threshold (step SP22: NO), next in step SP24, the information processing unit 11 selects the second generation method without remapping for the input image D1.

In a case where the input image D1 is a complex image or the like including fine texture, the spatial correlation in each of the plurality of feature maps FM is low. In this case, the compression efficiency is improved by applying the first generation method and performing encoding utilizing the correlation at the same position of the plurality of feature maps FM. In addition, since the occurrence of unnecessary padding can be avoided, the encoding efficiency is improved.

In a case where the input image D1 is a flat image or the like with little change, the spatial correlation in each of the plurality of feature maps FM is high. In this case, the compression efficiency is improved by applying the second generation method and performing encoding utilizing the spatial correlation of the plurality of feature maps FM.

Furthermore, for example, the information processing unit 11 may switch in units of layers by selecting the second generation method without remapping for the P2 layer and the P3 layer which are upper layers and selecting the first generation method with remapping for the P4 layer and the P5 layer which are lower layers.

In the upper layer in which a relatively large number of features of the input image D1 having spatial continuity remain, the compression efficiency is improved by applying the second generation method and performing encoding utilizing the spatial continuity of the plurality of feature maps FM.

In the lower layer in which the features of the input image D1 having spatial continuity disappear, the compression efficiency is improved by applying the first generation method and performing encoding utilizing the correlation at the same position of the plurality of feature maps FM. In addition, since the occurrence of unnecessary padding can be avoided, the encoding efficiency is improved.

Furthermore, in the examples illustrated in FIGS. 4 and 19, the information processing unit 11 arranges the plurality of unit feature maps UFM having different layers in different sub-pictures SP, but the present invention is not limited to this example. The information processing unit 11 may arrange a plurality of unit feature maps UFM having different layers in different pictures P. Alternatively, the information processing unit 11 may encode a plurality of unit feature maps UFM having different layers into different bitstreams D2.

### (Process of Decoding Device 2)

Since the process of the decoder 2 is basically the reverse of the process of the encoder 1, only the outline of the processing of the decoder 2 will be described below, and detailed description will be omitted.

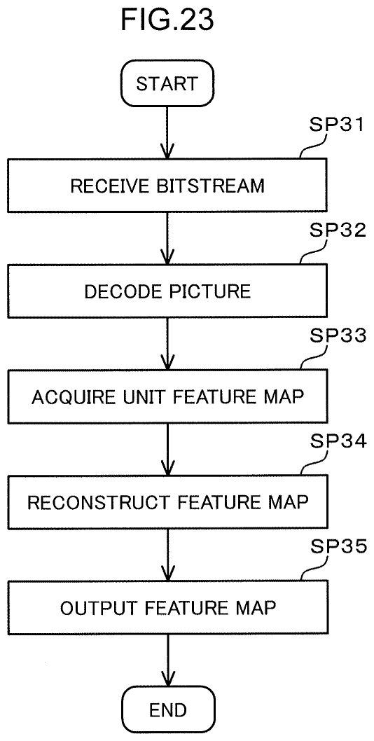

FIG. 23 is a flowchart illustrating processing executed by the information processing unit 21 of the decoder 2.

First, in step SP31, the information processing unit 21 receives the bitstream D2 transmitted from the encoder 1.

Next, in step SP32, the information processing unit 21 decodes the picture P in which the plurality of encoded blocks B corresponding to the plurality of unit feature maps UFM are arranged based on the bitstream D2 received in step SP31. Further, the information processing unit 21 decodes the syntax information or the index information from the header region R1 of the bitstream D2. Accordingly, the generation method of the unit feature map UFM and the generation method of the picture P designated by the encoder 1 are acquired.

As described above, the plurality of unit feature maps UFM are generated based on the plurality of feature maps FM by packing the plurality of pixel sets G included in the at least one feature map FM into the at least one encoded block B. Furthermore, in the picture P, the upper left boundary of each unit feature map UFM is matched with the upper left boundary of any encoded block B.

Next, in step SP33, the information processing unit 21 acquires a plurality of unit feature maps UFM based on the picture P decoded in step SP32.

Next, in step SP34, the information processing unit 21 reconstructs the plurality of feature maps FM based on the plurality of unit feature maps UFM acquired in step SP33.

Next, in step SP35, the information processing unit 21 outputs the plurality of feature maps FM reconfigured in step SP34, performs processing of the neural network 25 on the plurality of reconstructed feature maps FM, and outputs data D3 including information of the extracted ROI region. The data D3 is input to the machine task processing unit 3. Note that the neural network 25 may have one or more layers.

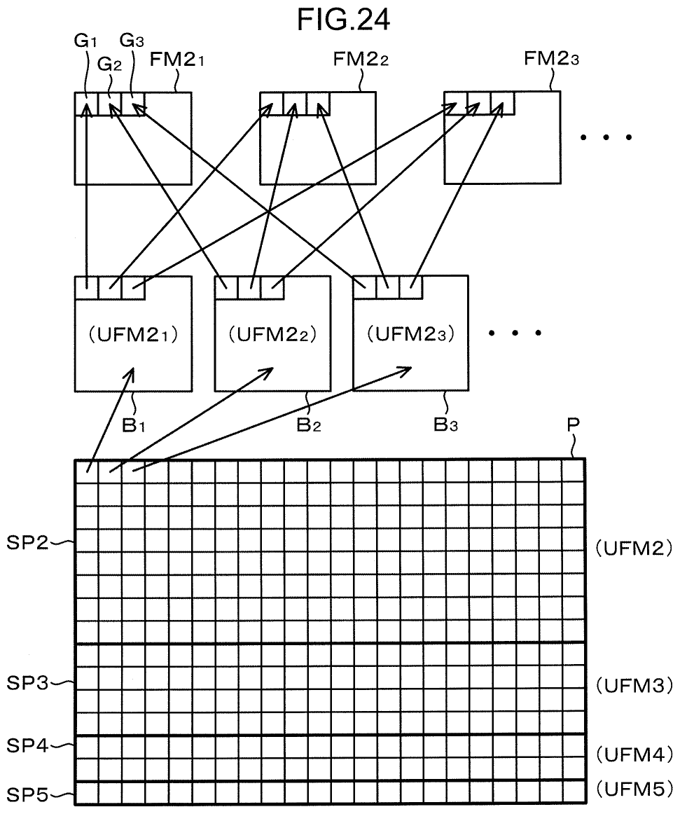

FIG. 24 is a diagram schematically illustrating a process of reconstructing the feature map FM in correspondence with FIG. 4. In each layer, the information processing unit 21 extracts the unit feature map UFM from each encoded block B in the picture P, and distributes a plurality of pixel sets G included in one unit feature map UFM to a plurality of feature maps FM. In the example illustrated in FIG. 24, the pixel set G includes one pixel.

For example, in the P2 layer, the information processing unit 21 extracts the unit feature map UFM2₁ from the encoded block B₁ in the sub-picture SP2, and distributes the 256 pixel sets G₁ included in the unit feature map UFM2₁ to the same position (first row and first column) of the 256 feature maps FM2₁ to FM2₂₅₆. Furthermore, the information processing unit 21 extracts the unit feature map UFM2₂ from the encoded block B₂ in the sub-picture SP2, and distributes the 256 pixel sets G₂ included in the unit feature map UFM2₂ to the same position (first row and second column) of the 256 feature maps FM2₁ to FM2₂₅₆.

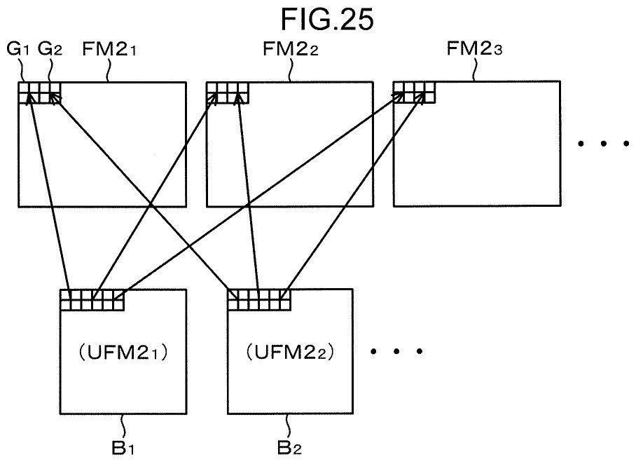

FIG. 25 is a diagram schematically illustrating a process of reconstructing the feature map FM in correspondence with FIG. 17. Similarly to the above, in each layer, the information processing unit 21 extracts the unit feature map UFM from each encoded block B in the picture P, and distributes a plurality of pixel sets G included in one unit feature map UFM to a plurality of feature maps FM. In the example illustrated in FIG. 25, the pixel set G includes four pixels.

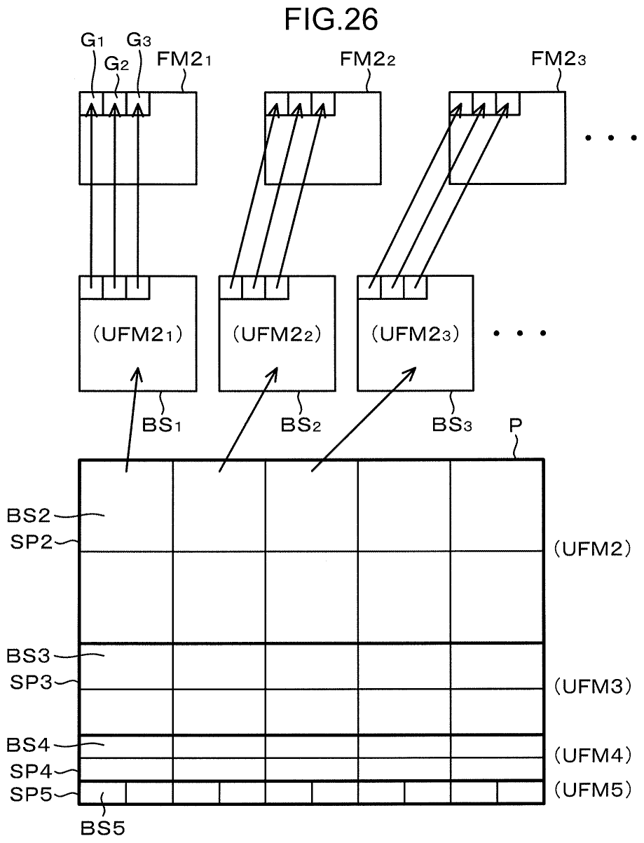

FIG. 26 is a diagram schematically illustrating a process of reconstructing the feature map FM in correspondence with FIG. 19. In each layer, the information processing unit 21 extracts a unit feature map UFM from each encoded block set BS in the picture P, and stores a plurality of pixel sets G included in one unit feature map UFM in one feature map FM. In the example illustrated in FIG. 26, the pixel set G includes one pixel.

For example, in the P2 layer, the information processing unit 21 extracts the unit feature map UFM2₁ from the encoded block set BS1 in the sub-picture SP2, and stores all the pixel sets G included in the unit feature map UFM2₁ in one feature map FM2₁. That is, the information processing unit 21 reconstructs the feature map FM2₁ by copying the unit feature map UFM2₁. Furthermore, the information processing unit 21 extracts the unit feature map UFM2₂ from the encoded block set BS2 in the sub-picture SP2, and stores all the pixel sets G included in the unit feature map UFM2₂ in one feature map FM2₂. That is, the information processing unit 21 reconstructs the feature map FM2₂ by copying the unit feature map UFM2₂.

### SUMMARY

According to the present embodiment, in generating the unit feature map UFM, the encoder 1 matches the upper left boundary of each unit feature map UFM with the upper left boundary of any of the encoded blocks B. As a result, it is possible to avoid the boundary of the plurality of feature maps FM from being included in one encoded block B, and thus, it is possible to improve the compression efficiency at the time of encoding.

Furthermore, according to the present embodiment, in generating the unit feature map UFM, the encoder 1 generates one unit feature map UFM by collecting the pixel set G at the same position included in each feature map FM from the plurality of feature maps FM included in each layer, and packing the plurality of collected pixel sets G in one encoded block B. As a result, it is possible to improve the compression efficiency when encoding the plurality of feature maps FM having a low spatial correlation.

Furthermore, according to the present embodiment, in generating the unit feature map UFM, the encoder 1 generates one unit feature map UFM by packing one feature map FM into one encoded block set BS or by packing a plurality of feature maps FM into one encoded block set BS. As a result, it is possible to improve the compression efficiency when encoding a plurality of feature maps FM having a high spatial correlation.

The present disclosure is particularly useful for application to an object detection system or the like using neural networks for machine tasks.

1. An encoder comprising:
circuitry; and
a memory connected to the circuitry,
wherein the circuitry is configured to execute:
generating, based on an input image, a plurality of feature maps having one or more layers;
generating, based on the plurality of feature maps, a plurality of unit feature maps by packing a plurality of pixels included in at least one feature map into at least one encoded block;
generating a picture by arranging a plurality of encoded blocks corresponding to the plurality of unit feature maps;
encoding the picture into a bitstream; and
matching, in the generating of the unit feature maps, an upper left boundary of each unit feature map with an upper left boundary of any encoded block.

2. The encoder according to claim 1, wherein
the picture is a plurality of pictures, and
in the generating of the picture, a plurality of encoded blocks are arranged in different pictures, the plurality of encoded blocks corresponding to a plurality of unit feature maps having different layers.

3. The encoder according to claim 1, wherein
the picture includes a plurality of sectioned regions, and
in the generating of the picture, a plurality of encoded blocks are arranged in different sectioned regions, the plurality of encoded blocks corresponding to a plurality of unit feature maps having different layers.

4. The encoder according to claim 3, wherein the sectioned region includes a sub-picture, a tile, or a slice.

5. The encoder according to claim 1, wherein, in the encoding of the bitstream, syntax information or index information designating a generation method of the unit feature map and a generation method of the picture is encoded into a supplemental enhancement information (SEI) region or another header region of the bitstream.

6. The encoder according to claim 1, wherein, in the generating of the unit feature map, one unit feature map is generated by collecting a pixel set at a same position included in each feature map from a plurality of feature maps included in each layer of the one or more layers, and packing a plurality of collected pixel sets in one encoded block.

7. The encoder according to claim 6, wherein the pixel set is one pixel or two or more adjacent pixels.

8. The encoder according to claim 6, wherein, in the generating of the unit feature map, a size of an encoded block in each layer of the one or more layers is set based on a number of feature maps included in each layer of the one or more layers and a number of pixels included in the pixel set.

9. The encoder according to claim 6, wherein, in the generating of the unit feature map, a plurality of collected pixel sets are arranged in the encoded block in a designated scan order.

10. The encoder according to claim 9, wherein, in the generating of the unit feature map, in a case where the encoded block includes a surplus pixel in which no pixel set is stored, the surplus pixel is padded using a specific value.

11. The encoder according to claim 6, wherein, in the generating of the picture, a number of encoded blocks included in each layer of the one or more layers is set based on a number of pixels included in a feature map, the feature map being included in each layer of the one or more layers, and a number of pixels included in the pixel set.

12. The encoder according to claim 6, wherein
the picture includes a plurality of sectioned regions, and
in the generating of the picture,
a plurality of encoded blocks corresponding to a plurality of unit feature maps having different layers are arranged in different sectioned regions, and
in a case where each sectioned region includes a surplus encoded block in which the unit feature map is not stored, the surplus encoded block is padded using a specific value.

13. The encoder according to claim 6, wherein
the picture includes a plurality of sectioned regions,
in the generating of the picture, a plurality of encoded blocks corresponding to a plurality of unit feature maps having different layers are arranged in different sectioned regions,
at least one of a number of feature maps and a number of pixels included in each layer of the one or more layers differs according to a layer,
a size of an encoded block included in each layer of the one or more layers is different according to a number of feature maps included in each layer of the one or more layers, and
a number of encoded blocks included in each layer of the one or more layers differs according to a number of pixels of a feature map included in each layer of the one or more layers.

14. The encoder according to claim 6, wherein
in the generating of the picture,
a surplus encoded block is padded using a specific value in a case where the surplus encoded block is included in at least one region of an upper end, a lower end, a left end, and a right end of the picture, the surplus encoded block being a block in which the unit feature map is not stored, and
the padded region is designated by crop information of the picture.

15. The encoder according to claim 1, wherein, in the generating of the unit feature map, one unit feature map is generated by packing one feature map into one encoded block set or by packing a plurality of feature maps into one encoded block set.

16. The encoder according to claim 15, wherein the encoded block set is one encoded block or two or more adjacent encoded blocks.

17. The encoder according to claim 15, wherein, in the generating of the unit feature map, a size of an encoded block set in each layer of the one or more layers is set based on a number of pixels of a feature map included in each layer of the one or more layers.

18. The encoder according to claim 15, wherein, in the generating of the unit feature map, in a case where the encoded block set includes a surplus pixel in which no unit feature map is stored, the surplus pixel is padded using a specific value.

19. The encoder according to claim 15, wherein, in the generating of the picture, a number of encoded block sets included in each layer of the one or more layers is set based on a number of feature maps included in each layer of the one or more layers.

20. The encoder according to claim 15, wherein
the picture includes a plurality of sectioned regions, and
in the generating of the picture,
a plurality of encoded block sets corresponding to a plurality of unit feature maps having different layers are arranged in different sectioned regions, and
in a case where each sectioned region includes a surplus encoded block set in which the unit feature map is not stored, the surplus encoded block set is padded using a specific value.

21. The encoder according to claim 15, wherein
the picture includes a plurality of sectioned regions,
in the generating of the picture, a plurality of encoded block sets corresponding to a plurality of unit feature maps having different layers are arranged in different sectioned regions,
at least one of a number of feature maps and a number of pixels included in each layer of the one or more layers differs according to a layer,
a number of encoded block sets included in each layer of the one or more layers is different according to a number of feature maps included in each layer of the one or more layers, and
a size of an encoded block set included in each layer of the one or more layers differs according to a number of pixels of a feature map included in each layer of the one or more layers.

22. The encoder according to claim 15, wherein
the picture includes a plurality of sectioned regions,
in the generating of the picture, a plurality of encoded block sets corresponding to a plurality of unit feature maps having different layers are arranged in different sectioned regions,
a size of an encoded block included in each layer of the one or more layers is common in a plurality of layers,
a number of pixels of a feature map included in each layer of the one or more layers differs according to a layer, and
a number of encoded blocks included in an encoded block set in each layer of the one or more layers differs according to a number of pixels of a feature map included in each layer of the one or more layers.

23. The encoder according to claim 15, wherein
in the generating of the picture,
a surplus encoded block set is padded using a specific value in a case where the surplus encoded block set is included in at least one region of an upper end, a lower end, a left end, and a right end of the picture, the surplus encoded block being a block in which the unit feature map is not stored, and
the padded region is designated by crop information of the picture.

24. The encoder according to claim 1, wherein
in the generating of the unit feature map,
a first generation method and a second generation method are switched in units of pictures or in units of layers, the first generation method being generating one unit feature map by collecting a pixel set at a same position included in each feature map from a plurality of feature maps included in each layer of the one or more layers and packing a plurality of collected pixel sets in one encoded block, and the second generation method being generating one unit feature map by packing one feature map into one encoded block set or by packing a plurality of feature maps into one encoded block set.

25. A decoder comprising:
circuitry; and
a memory connected to the circuitry,
wherein the circuitry is configured to execute:
decoding, based on a bitstream, a picture in which a plurality of encoded blocks corresponding to a plurality of unit feature maps are arranged,
the plurality of unit feature maps being generated based on a plurality of feature maps by packing a plurality of pixels included in at least one feature map into at least one encoded block,
the plurality of feature maps having one or more layers,
in the picture, an upper left boundary of each unit feature map being matched with an upper left boundary of any encoded block;
acquiring the plurality of unit feature maps based on the picture; and
reconstructing the plurality of feature maps based on the plurality of unit feature maps.

26. The decoder according to claim 25, wherein
the picture is a plurality of pictures, and
a plurality of encoded blocks are arranged in different pictures, the plurality of encoded blocks corresponding to a plurality of unit feature maps having different layers.

27. The decoder according to claim 25, wherein
the picture includes a plurality of sectioned regions, and
a plurality of encoded blocks are arranged in different sectioned regions, the plurality of encoded blocks corresponding to a plurality of unit feature maps having different layers.

28. The decoder according to claim 27, wherein the sectioned region includes a sub-picture, a tile, or a slice.

29. The decoder according to claim 25, wherein, in the decoding of the picture, syntax information or index information designating a generation method of the unit feature map and a generation method of the picture is decoded from a supplemental enhancement information (SEI) region or another header region of the bitstream.

30. The decoder according to claim 25, wherein one unit feature map is generated by collecting a pixel set at a same position included in each feature map from a plurality of feature maps included in each layer of the one or more layers, and packing a plurality of collected pixel sets in one encoded block.

31. The decoder according to claim 30, wherein the pixel set is one pixel or two or more adjacent pixels.

32. The decoder according to claim 30, wherein a size of an encoded block in each layer of the one or more layers is set based on a number of feature maps included in each layer of the one or more layers and a number of pixels included in the pixel set.

33. The decoder according to claim 30, wherein a plurality of collected pixel sets are arranged in the encoded block in a designated scan order.

34. The decoder according to claim 33, wherein, in a case where the encoded block includes a surplus pixel in which no pixel set is stored, the surplus pixel is padded using a specific value.

35. The decoder according to claim 30, wherein a number of encoded blocks included in each layer of the one or more layers is set based on a number of pixels included in a feature map, the feature map being included in each layer of the one or more layers, and a number of pixels included in the pixel set.

36. The decoder according to claim 30, wherein
the picture includes a plurality of sectioned regions,
a plurality of encoded blocks corresponding to a plurality of unit feature maps having different layers are arranged in different sectioned regions, and
in a case where each sectioned region includes a surplus encoded block in which the unit feature map is not stored, the surplus encoded block is padded using a specific value.

37. The decoder according to claim 30, wherein
the picture includes a plurality of sectioned regions,
a plurality of encoded blocks corresponding to a plurality of unit feature maps having different layers are arranged in different sectioned regions,
at least one of a number of feature maps and a number of pixels included in each layer of the one or more layers differs according to a layer,
a size of an encoded block included in each layer of the one or more layers is different according to a number of feature maps included in each layer of the one or more layers, and
a number of encoded blocks included in each layer of the one or more layers differs according to a number of pixels of a feature map included in each layer of the one or more layers.

38. The decoder according to claim 30, wherein
a surplus encoded block is padded using a specific value in a case where the surplus encoded block is included in at least one region of an upper end, a lower end, a left end, and a right end of the picture, the surplus encoded block being a block in which the unit feature map is not stored, and
the padded region is designated by crop information of the picture.

39. The decoder according to claim 25, wherein one unit feature map is generated by packing one feature map into one encoded block set or by packing a plurality of feature maps into one encoded block set.

40. The decoder according to claim 39, wherein the encoded block set is one encoded block or two or more adjacent encoded blocks.

41. The decoder according to claim 39, wherein a size of an encoded block set in each layer of the one or more layers is set based on a number of pixels of a feature map included in each layer of the one or more layers.

42. The decoder according to claim 39, wherein, in a case where the encoded block set includes a surplus pixel in which no unit feature map is stored, the surplus pixel is padded using a specific value.

43. The decoder according to claim 39, wherein a number of encoded block sets in each layer of the one or more layers is set based on a number of feature maps included in each layer of the one or more layers.

44. The decoder according to claim 39, wherein
the picture includes a plurality of sectioned regions,
a plurality of encoded block sets corresponding to a plurality of unit feature maps having different layers are arranged in different sectioned regions, and
in a case where each sectioned region includes a surplus encoded block set in which the unit feature map is not stored, the surplus encoded block set is padded using a specific value.

45. The decoder according to claim 39, wherein
the picture includes a plurality of sectioned regions,
a plurality of encoded block sets corresponding to a plurality of unit feature maps having different layers are arranged in different sectioned regions,
at least one of a number of feature maps and a number of pixels included in each layer of the one or more layers differs according to a layer,
a number of encoded block sets included in each layer of the one or more layers is different according to a number of feature maps included in each layer of the one or more layers, and
a size of an encoded block set included in each layer of the one or more layers differs according to a number of pixels of a feature map included in each layer of the one or more layers.

46. The decoder according to claim 39, wherein
the picture includes a plurality of sectioned regions,
a plurality of encoded block sets corresponding to a plurality of unit feature maps having different layers are arranged in different sectioned regions,
a size of an encoded block included in each layer of the one or more layers is common in a plurality of layers,
a number of pixels of a feature map included in each layer of the one or more layers differs according to a layer, and
a number of encoded blocks included in an encoded block set in each layer of the one or more layers differs according to a number of pixels of a feature map included in each layer of the one or more layers.

47. The decoder according to claim 39, wherein
a surplus encoded block set is padded using a specific value in a case where the surplus encoded block set is included in at least one region of an upper end, a lower end, a left end, and a right end of the picture, the surplus encoded block being a block in which the unit feature map is not stored, and
the padded region is designated by crop information of the picture.

48. The decoder according to claim 25, wherein a first generation method and a second generation method are switched in units of pictures or in units of layers, the first generation method being generating one unit feature map by collecting a pixel set at a same position included in each feature map from a plurality of feature maps included in each layer of the one or more layers and packing a plurality of collected pixel sets in one encoded block, and the second generation method being generating one unit feature map by packing one feature map into one encoded block set or by packing a plurality of feature maps into one encoded block set.

49. An encoding method for causing an encoder to execute:
generating, based on an input image, a plurality of feature maps having one or more layers;
generating, based on the plurality of feature maps, a plurality of unit feature maps by packing a plurality of pixels included in at least one feature map into at least one encoded block;
generating a picture by arranging a plurality of encoded blocks corresponding to the plurality of unit feature maps;
generating a bitstream by encoding the picture; and
matching, in the generating of the unit feature maps, an upper left boundary of each unit feature map with an upper left boundary of any encoded block.

50. A decoding method for causing a decoder to execute:
decoding, based on a bitstream, a picture in which a plurality of encoded blocks corresponding to a plurality of unit feature maps are arranged,
the plurality of unit feature maps being generated based on a plurality of feature maps by packing a plurality of pixels included in at least one feature map into at least one encoded block,
the plurality of feature maps having one or more layers,
in the picture, an upper left boundary of each unit feature map being matched with an upper left boundary of any encoded block;
acquiring the plurality of unit feature maps based on the picture; and
reconstructing the plurality of feature maps based on the plurality of unit feature maps.
